(19) United States
(12) Patent Application Publication
(10) Pub. No.: US 2026/0295558 A1
(43) Pub. Date: Oct. 1, 2026

(54) HIGH PERFORMANCE CO2 ADSORBENTS MADE FROM NATURAL SILK

(71) Applicant: Wisconsin Alumni Research Foundation, Madison, WI (US)

(72) Inventors: Bu Wang, Verona, WI (US); Md Sariful Sheikh, Madison, WI (US)

(73) Assignee: Wisconsin Alumni Research Foundation, Madison, WI (US)

(21) Appl. No.: 19/095,932

(22) Filed: Mar. 31, 2025

(51) Int. Cl. B01J 20/24; B01D 53/62; B01D 53/81; B01J 20/28; B01J 20/30

(52) U.S. Cl. CPC B01J 20/24; B01D 53/62; B01D 53/81; B01J 20/28047; B01J 20/28059; B01J 20/28061; B01J 20/28064; B01J 20/28066; B01J 20/28071; B01J 20/28073; B01J 20/3085; B01D 2253/202; B01D 2257/504

(57) ABSTRACT

A solid amino acid-based CO₂ sorbent derived from silk fibroin, and the use of the sorbent for CO₂ capture. The silk fibroin may be provided in the form of nanoparticles or an aerogel, free of solid or porous support. Mechanical reinforcements using materials such as graphene nanorods could be incorporated for enhancing mechanical rigidity and long-term operational stability. The silk fibroin-based sorbent offers high CO₂ adsorption capacity, low CO₂ desorption temperature, high thermal stability, natural synthesis, eco-friendly nature, light weight, and high level of mechanical flexibility, making it a superior CO₂ adsorber.

### BACKGROUND

Carbon capture, storage, and utilization is considered an important strategy to manage anthropogenic CO₂ emissions and mitigate the adverse effects of ever-increasing atmospheric CO₂ levels. CO₂ capture technologies using aqueous amine solutions have been practically available for several decades. (See D'Alessandro et al. “Carbon Dioxide Capture: Prospects for New Materials.” Angewandte Chemie International Edition, 2010, 49, 6058). However, the wide implementation of amine solvent-based technologies is restricted due to its poor thermal stability, high regeneration energy cost due to the high CO₂ desorption temperature, vaporization loss of amines due to its high vapor pressure, corrosion of the process equipment, and the adverse environmental impact of amine production and fugitive amines (D'Alessandro et al. “Carbon Dioxide Capture: Prospects for New Materials.” Angewandte Chemie International Edition, 2010, 49, 6058; Hack et al. “Review on CO₂ Capture Using Amine-Functionalized Materials.” ACS Omega. 2022, 7, 39520; Sefidi et al. “Advanced Amino Acid-Based Technologies for CO₂ Capture: A Review.” Ind. Eng. Chem. Res. 2019, 58, 20181; Zhao et al. “Investigation of Thermal Stability and Continuous CO₂ Capture from Flue Gases with Supported Amine Sorbent.” Ind. Eng. Chem. Res. 2013, 52, 2084).

In recent years, amino acid-based CO₂ absorbents have drawn significant research attention due to their amine-like CO₂ sorption behavior, promising CO₂ adsorption capacity, high thermal stability, nonvolatility, and eco-friendly nature. (See Sefidi et al. “Advanced Amino Acid-Based Technologies for CO₂ Capture: A Review.” Ind. Eng. Chem. Res. 2019, 58, 20181; Hu et al. “Carbon Dioxide Capture by Solvent Absorption Using Amino Acids: A Review.” Chin. J. Chem. Eng. 2018, 26, 2229; Ramezani et al. “State-of-the-Art of CO₂ Capture with Amino Acid Salt Solutions.” Rev. Chem. Eng. 2022, 38, 273.) Nonetheless, it still has several drawbacks similar to the aqueous amine solvents. The high viscosity of aqueous solvents slows down CO₂ sorption and desorption kinetics, thereby restricting the practically achievable sorption capacity (Raganati et al. “Adsorption of Carbon Dioxide for Post-Combustion Capture: A Review” Energy Fuels 2021, 35, 12845). The regeneration of spent aqueous amino acid solutions requires intensive heat energy due to the high heat capacity of water, resulting in high operating costs and process emissions (Rabensteiner et al. “PCC Pilot Plant Studies with Aqueous Potassium Glycinate.” Int. J. Greenh. Gas Control. 2015, 42, 562; Alivand et al. “Development of Aqueous-Based Phase Change Amino Acid Solvents for Energy-Efficient CO₂ Capture: The Role of Antisolvent.” Appl. Energy. 2019, 256, 113911). Alternatively, amino acid based ionic liquids (AAILs) have shown higher CO₂ adsorption capacity than pure amino acids. (See Saravanamurugan et al. “Amine-Functionalized Amino Acid-Based Ionic Liquids as Efficient and High-Capacity Absorbents for CO₂.” ChemSusChem 2014, 7, 897.) However, they also face high synthesis cost and high viscosity issues.

To address these challenges, a strategy of immobilizing adsorbents onto nano-porous solid surface has been adopted. (See e.g., Charalambous et al. “A Holistic Platform for Accelerating Sorbent-Based Carbon Capture.” Nature 2024, 632, 89; Mao et al. “A Scalable Solid-State Nanoporous Network with Atomic-Level Interaction Design for Carbon Dioxide Capture.” Sci. Adv. 2022, 8, eabo6849; Lu et al. “Advanced Materials and Technologies toward Carbon Neutrality” Acc. Mater. Res. 2022, 3, 913; D'Alessandro et al. “Carbon Dioxide Capture: Prospects for New Materials.” Angewandte Chemie International Edition 2010, 49, 6058; Raganati et al. “Adsorption of Carbon Dioxide for Post-Combustion Capture: A Review.” Energy Fuels 2021, 35, 12845; Li et al. “Capturing Carbon Dioxide from Air with Charged-Sorbents.” Nature 2024, 630, 654; Shi et al. “Sorbents for the Direct Capture of CO₂ from Ambient Air.” Angewandte Chemie International Edition 59, 2020, 6984.) The high surface area of the nano-porous substrate significantly reduces desorption energy costs by eliminating the presence of water. In this approach, desorption can be performed using steam, vacuum, or direct heating. Various nano-porous solids, such as silica gel, metal organic frameworks (MOFs), polymers, and aerogels, have been explored as solid support for amino acid grafting or impregnation. (See e.g., Sun et al. “Porous Amino Acid-Functionalized Poly(Ionic Liquid) Foamed with Supercritical CO₂ and Its Application in CO₂ Adsorption.” Chem. Eng. J. 2021, 412, 128764; Mohamed Hatta et al. “A Systematic Review of Amino Acid-Based Adsorbents for CO₂ Capture.” Energies 2022, 15, 10; Wang et al. “Amino Acid-Functionalized Ionic Liquid Solid Sorbents for Post-Combustion Carbon Capture.” ACS Appl. Mater. Interfaces 2013, 5, 8670; Uehara et al. “Amino Acid Ionic Liquid-Modified Mesoporous Silica Sorbents with Remaining Surfactant for CO₂ Capture.” Adsorption 2019, 25, 703.) Various amino acids and AAILs-based porous solid sorbents have demonstrated high CO₂ adsorption capacity. Although promising, the solid amino acid sorbents need further improvements in synthesis cost, CO₂ adsorption capacity, desorption kinetics, and cycling stability (Hatta et al. “A Systematic Review of Amino Acid-Based Adsorbents for CO₂ Capture.” Energies 2022, 15, 10; Dong et al. “Post Synthesis of a Glycine-Functionalized Covalent Triazine Framework with Excellent CO₂ Capture Performance.” Microporous Mesoporous Mater. 2020, 306, 110475; Lyu et al. “Carbon Dioxide Capture Chemistry of Amino Acid Functionalized Metal-Organic Frameworks in Humid Flue Gas.” J. Am. Chem. Soc. 2022, 144, 2387). Issues such as pore-blocking during amino acid grafting or impregnation, insufficient loading of amino acid, and the collapse of porous support materials during operation can negatively impact overall performance, limiting the practical implementation of these sorbents (Sun et al. “Porous Amino Acid-Functionalized Poly(Ionic Liquid) Foamed with Supercritical CO₂ and Its Application in CO₂ Adsorption.” Chem. Eng. J. 2021, 412, 128764; Hatta et al. “A Systematic Review of Amino Acid-Based Adsorbents for CO₂ Capture.” Energies 2022, 15, 10; Jiang et al. “Development of Amino Acid and Amino Acid-Complex Based Solid Sorbents for CO₂ Capture.” Appl. Energy. 2013, 109, 112; Huang et al. “Study on the Efficiency of Multiple Amino Groups in Ionic Liquids on Their Sorbents Performance for Low-Temperature CO₂ Capture.” Chem. Eng. Res. Des. 2021, 167, 198).

The present disclosure addresses the limitations of existing technologies and provides novel sorbents for cost-effective CO₂ capture.

### SUMMARY

Disclosed herein is a method for capturing carbon dioxide (CO₂) from a CO₂-containing gas, comprising contacting the CO₂-containing gas with a sorbent comprising silk fibroin, wherein at least a portion of CO₂ in the CO₂-containing gas is captured by the silk fibroin.

The form and preparation methods of the silk fibroin are not limited. Preferably, the silk fibroin is degummed and in a solid form. Preferably, the silk fibroin has a nanostructure.

In one version, the silk fibroin is in the form of nanoparticles. The silk fibroin nanoparticles may be prepared by subjecting degummed silk fibroin to partial acid hydrolysis with an acid solution comprising H₂SO₄ to form a first dispersion comprising silk fibroin particles, mechanically separating the particles from the acid solution, redispersing the separated particles in water to form a second dispersion, freezing the second dispersion, and lyophilizing the frozen dispersion to obtain the silk fibroin nanoparticles.

In another version, the silk fibroin is in the form of an aerogel. The aerogel may be prepared by dissolving degummed silk fibroin in a solution comprising LiBr, and dialyzing the solution against an aqueous medium to remove LiBr to obtain an aqueous silk fibroin solution. The method further comprises freezing the aqueous silk fibroin solution, and lyophilizing the frozen solution to obtain the aerogel. Alternatively, the method comprising allowing the aqueous silk fibroin solution to stand for a period time to form a hydrogel, freezing the hydrogel, and lyophilizing the frozen hydrogel to obtain the aerogel. Alternatively, the aerogel may be prepared from the hydrogel using CO₂ critical point drying or N₂ critical point drying methods.

The silk nano-fibroin prepared using the methods described herein exhibits a high surface area and large pore volume. In some embodiments, the silk fibroin may have a specific surface area ranging from 50-1500 m²/g as measured by the Brunauer-Emmett-Teller (BET) method, and an effective pore volume ranging from 0.1 to 0.8 cc/g.

The method further comprises regenerating the sorbent after the CO₂ capture at a temperature not exceeding 100° C. The regeneration temperature is substantially lower than that of various state-of-the-art solid sorbents, thereby reducing the overall energy consumption for CO₂ capture.

The sorbent disclosed herein is free of solid or porous support, thereby reducing the cost associated with synthesizing such supports and eliminating issues related to the collapse of porous support materials. However, the method may further comprise, prior to contacting the CO₂-containing gas, reinforcing the sorbent by incorporating into the sorbent a reinforcing material selected from a polymer, a fiber, and a nanoparticle. In certain versions, the reinforcing material may comprise a graphene or carbon-based material. Non-limiting examples of the reinforcing material include reduced graphene oxide nanorods. The reinforcement can further improve the long-term operation stability of the sorbent. The method of reinforcement involves incorporating the reinforcing material into the sorbent and thus differs from surface grafting/impregnating of a porous solid support.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1. A schematic of the porous silk-nanoparticles (SNP) synthesis from mulberry silk cocoon.

FIG. 2. A schematic of silk fibroin aerogel preparation from aqueous silk-fibroin solution.

FIG. 3. (a) Optical image of the mulberry silk cocoon. (b) Field effect scanning electron microscope (FESEM) image of the raw silk fiber. (c) FESEM image of the degummed silk fiber. (d, e, f) FESEM images of the SNP at various resolutions.

FIG. 4. (a, b, c) AFM topography image; (d, e, f) simultaneously acquired amplitudes; and (g, h, i) phase images of the SNP.

FIGS. 5A-5I. (FIG. 5A) FESEM image of the porous silk-nanoparticles (SNP). Inset shows their particle size distribution. (FIG. 5B) The measured bulk N and C-atomic percentage in the degummed silk and SNP. (FIG. 5C) Room temperature XRD patterns of the degummed silk, SNP, and the aerogels prepared by lyophilization of 0.06 wt % silk-fibroin solution (named as sol-0.06%@77K) and 0.25 wt % silk-fibroin hydrogel (named as gel-0.25%@77K) froze at 77K using liquid nitrogen. (FIG. 5D) Room temperature FTIR spectra of degummed silk, SNP, sol-0.06%@77K and gel-0.25%@77K in air. (FIGS. 5E, 5F, and 5G) Thermal stability test of SNP, sol-0.06%@77K and gel-0.25%@77K in N₂, O₂ and CO₂ environments using thermogravimetry. The heating rate was 5° C./min in all cases. (FIG. 5H) FESEM image of the sol-0.06%@77K aerogel. (FIG. 5I) FESEM image of the gel-0.25%@77K aerogel.

FIG. 6. FESEM images of silk-fibroin aerogel prepared using lyophilization of 2, 1, 0.5 and 0.25 wt % aqueous silk solution froze using refrigerator at 193 K (a-d), and liquid nitrogen at 77 K (e-h).

FIGS. 7A-7C. (FIGS. 7A and 7B) High resolution FESEM images of gel-0.25%@77K. (FIG. 7C) High resolution FESEM images of silk-nano sheets prepared using CO₂ critical point drying of 1 wt % silk hydrogel.

FIG. 8. N₂ adsorption desorption isotherm of (a) SNP, (b) sol-0.06%@77K and (c) gel-0.25%@77K at 77 K. Total specific surface area measurement of (d) SNP, (e) sol-0.06%@77K and (f) gel-0.25%@77K using BET method.

FIGS. 9A-9D. (FIG. 9A) Specific surface area of synthesized samples. (FIG. 9B) CO₂ adsorption-desorption isotherms at 5° C. of SNP and aerogels prepared using 0.06 wt % solution (sol-0.06%@77K) and 0.25 wt % hydrogel (gel-0.25%@77K). (FIG. 9C) A comparison of the adsorption capacity of silk-based materials with other state-of-the-art materials. (FIG. 9D) A comparison of differential adsorption enthalpy (ΔHads) of silk-fibroin-based sorbents with the state-of-the-art solid sorbents at 1 mmol/gm CO₂ adsorption capacity. The details of the ΔHads comparison data are represented in Table 2.

FIGS. 10A-10G. (FIG. 10A) CO₂ adsorption-desorption isotherms of SNP at various temperatures. (FIG. 10B) CO₂ adsorption-desorption isotherms of sol-0.06%@77K at various temperatures. (FIG. 10C) CO₂ adsorption-desorption isotherms of gel-0.25%@77K at various temperatures. (FIG. 10D) Temperature dependent CO₂ adsorption capacity of SNP as a function of pressure. (FIG. 10E) Temperature dependent CO₂ adsorption capacity of sol-0.06%@77K as a function of pressure. (FIG. 10F) Temperature dependent CO₂ adsorption capacity of gel-0.25%@77K as a function of pressure. (FIG. 10G) Comparison of CO₂ adsorption capacity of silk-fibroin-based sorbents at 5° C. and 1 atm pure CO₂ with some high performing amino acid based solid sorbents reported at 1 atm pure CO₂ near room temperature conditions (Table 1).

FIG. 11. lnP vs. 1/T plot of SNP at CO₂ adsorption capacity of (a) 1.5 mmol/gm, (b) 1.25 mmol/gm, (c) 1 mmol/gm, (d) 0.75 mmol/gm, (e) 0.5 mmol/gm, (f) 0.25 mmol/gm and (g) 0.1 mmol/gm.

FIG. 12. Differential adsorption enthalpy (4H_{ads}) of (a) SNP, (b) sol-0.06%@77K and (c) gel-0.25%@77K as a function of CO₂ adsorption capacity.

FIGS. 13A-13B. Cyclic CO₂ adsorption-desorption stability test of aerogel sol-0.06%@77K (FIG. 13A), and gel-0.25%@77K (FIG. 13B).

FIGS. 14A-14D. XPS survey scan of SNP drop-casted on a microscopic glass slide (FIG. 14A) before and (FIG. 14B) after 10 s of monoatomic Ar⁺ ion sputtering of energy 200 eV. (FIG. 14C) High resolution C1s spectra before and after 10 s of monoatomic Ar⁺ ion sputtering 200 eV. (FIG. 14D) FTIR spectra of SNP in aqueous dispersion before and after CO₂ adsorption. Inset shows the enlarged FTIR spectra of CO₂ adsorbed SNP after subtracting FTIR spectra of CO₂ desorbed SNP sample.

FIG. 15. Comparison of high resolution C1s spectra of SNP (a) before and (b) after 10 s of monoatomic Ar⁺ ion sputtering of energy 200 eV. The symbols represent the experimental data, and the solid lines represent the fitted data.

FIG. 16. Raman spectra of silk-fibroin-sorbent (gel-0.25%@77K) before and after CO₂ adsorption collected in N₂ and CO₂ environment, respectively.

FIG. 17A. CO₂ desorption kinetics of aerogel gel-0.25%@77K at 60° C. FIG. 17B. The mass changes as the sample temperature increases from 60 to 80° C. stepwise.

FIG. 18. Cyclic CO₂ adsorption and desorption at temperatures 5 and 60° C., respectively, using ~13.3% CO₂ balanced N₂ gas in (a) dry and (b) humid conditions (Relative humidity 83±2%).

### DETAILED DESCRIPTION

AAIL=Amino acid based ionic liquid; AFM=Atomic force microscopy; BET=Brunauer-Emmett-Teller; ΔH_{ads}=Differential heat of adsorption; FESEM=Field emission scanning electron microscopy; FTIR=Fourier Transform Infrared spectroscopy; MOFs=Metal organic frame works; NLDFT=Nonlocal density functional theory; SEM=Scanning electron microscope; SNP=Silk nano particles; sol-0.06%@77K=silk fibroin aerogel prepared using lyophilization of 0.06 wt % silk-fibroin solution froze at 77K using liquid nitrogen, gel-0.25%@77K=silk fibroin aerogel prepared using lyophilization of 0.25 wt % silk-fibroin hydrogel froze at 77K using liquid nitrogen, TGA=Thermogravimetric analysis; XPS=X-ray photoemission spectroscopy; XRD=X-ray diffraction.

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

The elements and method steps described herein can be used in any combination whether explicitly described or not.

All combinations of method steps as used herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful in the art. The disclosure provided herein suitably may be practiced in the absence of any element which is not specifically disclosed herein.

It is understood that the disclosure is not confined to the particular ingredients, compositions of matter, or steps herein illustrated and described, but embraces such modified forms thereof as come within the scope of the claims.

Disclosed herein is a solid amino acid-based CO₂ adsorbent derived from silk fibroin, and the use of the adsorbent for CO₂ capture.

Silk fibroin is a natural fibrous protein obtained from the silk of silkworms (e.g., Bombyx mori) or other silk-producing organisms. It is composed of a natural blend of amino acids and is organized into a structure with a high surface area, making it suitable for various applications. Typically, silk fibroin comprises approximately 42-46% glycine, 25-35% alanine, 10-15% serine, 4-6% tyrosine, 1-3% valine, 0.5-1.5% threonine, along with smaller amounts of other amino acids.

The silk fibroin suitable for use can be obtained in various forms, including, but not limited to, raw, degummed, regenerated, or modified, and can be processed into diverse materials such as films, fibers, gels, sponges, or nanoparticles. In preferred versions, the silk fibroin-based CO₂ adsorbent is solid support free, and is not combined or integrated in any form with other CO₂ adsorbents, including, but not limited to, zeolite, metal organic frameworks (MOFs), and various surface modified materials such as amino cellulose aerogels and quaternary amine group rich ion exchange resins. See e.g., He et al. “Innovative dual-function system for efficient CO₂ absorption and utilization: Local humidity swing fabric and microalgae-embedded hydrogel.” Chem. Eng. J. 2023, 477, 147108. While He et al. use silk fibroin for immobilizing ion exchange resin particles on fabrics for CO₂ capture, the present disclosure demonstrates superior CO₂ adsorption capacity of the CO₂ adsorbents derived from silk fibroin alone.

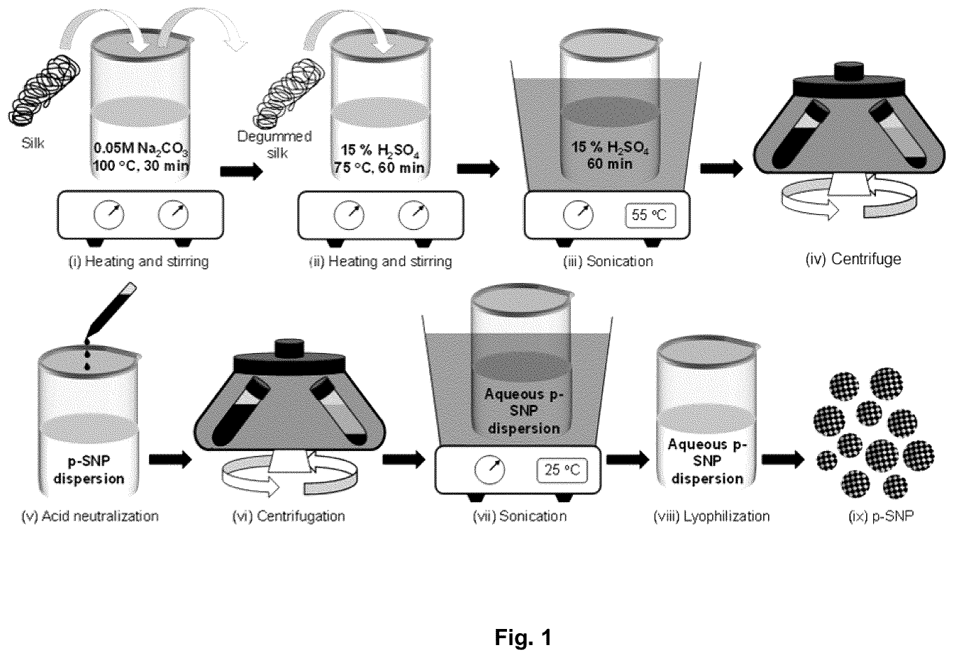

In one version, the silk fibroin is provided in the form of nanoparticles. The silk fibroin nanoparticles can be prepared using any methods currently known in the art or methods that may be developed in the future. An exemplary workflow for preparing the silk fibroin nanoparticles is shown in FIG. 1, which includes partial acid hydrolysis of degummed silk fibroin using 15% H₂SO₄ solution at 75° C. After acid hydrolysis, dispersed silk nanoparticles were separated from the acid solution by centrifuge and dispersed in DI water. The pH of the solution was neutralized using 0.5 M aqueous NaOH solution and centrifuged to remove the generated salt in the dispersion. Finally, the aqueous silk fibroin nanoparticles dispersion was frozen and lyophilized to obtain the high specific surface area CO₂ sorbent.

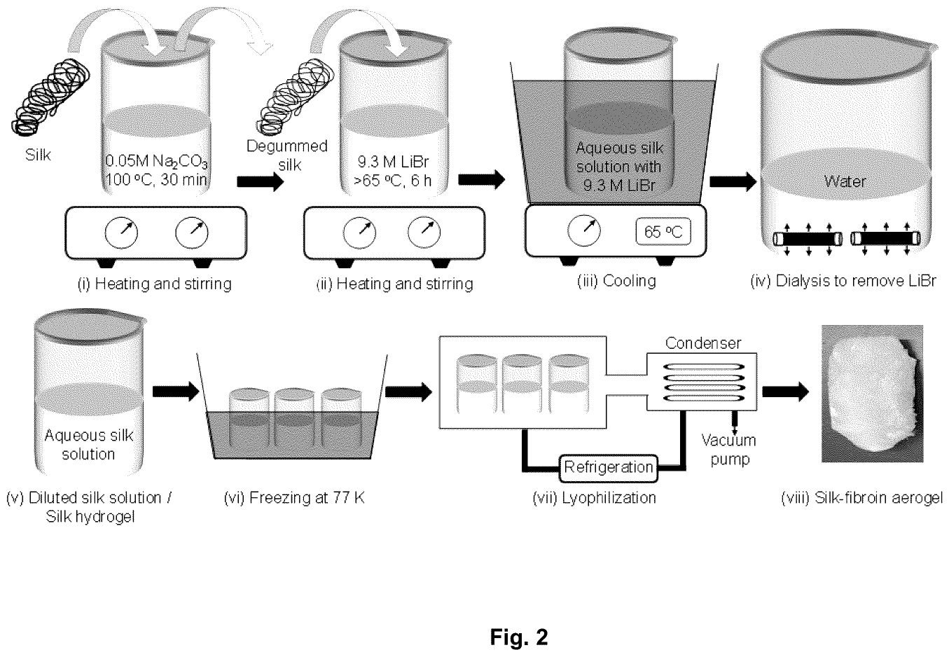

In another version, the silk fibroin is provided in the form of an aerogel. The silk fibroin aerogel may comprise silk fibroin nanowires, nanosheets, or a mixture of nanowires and nanosheets. The silk fibroin aerogel can be prepared using any methods currently known in the art or methods that may be developed in the future. An exemplary workflow for preparing the silk fibroin aerogel is shown in FIG. 2. The degummed silk fibroin was dissolved in 9.3 M LiBr solution by stirring at 65° C. for 4 h. Then the silk fibroin solution was dialyzed at 4° C. in a cellulose tube against water medium to remove the LiBr salt from the aqueous silk fibroin solution. The concentration of the silk fibroin solution was adjusted by adding water. The silk fibroin solution was then frozen and lyophilized to obtain the aerogel with a porous silk fibroin structure. Alternatively, a silk fibroin hydrogel can be formed from the silk fibroin solution, typically requiring 2 to 3 weeks and a silk fibroin concentration of more than 0.2%. The hydrogel is then frozen and lyophilized to produce an aerogel. Alternatively, the aerogel may be prepared from the hydrogel using CO₂ critical point drying or N₂ critical point drying.

The silk fibroin nanoparticles and aerogel prepared using the methods described herein exhibit a high specific surface area (ranging from 50-1500 m²/g as measured by the Brunauer-Emmett-Teller (BET) method) and effective pore volume (ranging from 0.1 to 0.8 cc/g).

As demonstrated in the present disclosure, silk nano-fibroin synthesized from Bombyx mori silk cocoon has substantially higher CO₂ adsorption capacity compared to various state-of-the-art sorbents, such as amino acids, amino acid ionic liquids, zeolite, metal organic frameworks (MOFs), and carbonaceous samples based solid sorbents. In addition, it demonstrates high thermal stability and cyclic operation stability.

It also has a low heat of adsorption and can be regenerated at low temperature, thereby reducing the overall energy consumption of CO₂ capture. The energy consumption in the CO₂ capture process is largely associated with the CO₂ desorption or solvent/sorbent regeneration process by applying heat. Silk has a low value of ΔH_{ads} when compared to various state-of-the-art solid sorbents. Hence, the silk nano fibroin-based solid sorbent can be regenerated by relatively lower temperature (<100° C.) than the traditional aqueous amines (desorption temperature 120-140° C.).

Sorbents based on pure amino acids, amino acid ionic liquids, and traditional amines are typically grafted onto porous structural support such as silica, polymers, metal-organic frameworks, alumina, or carbon. The synthesis of these porous supports requires additional preparation process. The collapse of the porous structure during operation also instigates the poor cyclic performance of these amino acids and amino acid ionic liquids grafted or impregnated solid sorbents. In contrast, the high surface area silk fibroin based adsorber does not require a porous solid support, as silk fibroin is light weight and mechanically flexible. However, mechanical reinforcement using materials such as reduced graphene oxide nanorods may be employed to improve its long-term operational stability.

Moreover, the CO₂ adsorber based on silk nano fibroin is relatively cheaper compared to the high performing ionic liquids, as synthesis of the ionic liquids requires a sophisticated procedure and costly chemicals.

In sum, as a natural blend of amino acids, silk has many advantages over the traditional amines and other solid sorbents. Silk fibroin offers high CO₂ adsorption capacity, low CO₂ desorption temperature, high thermal stability, natural synthesis, eco-friendly nature, light weight, and high level of mechanical flexibility, making it a superior CO₂ adsorber.

### EXAMPLES

Amino acid and amino acid based ionic liquid (AAIL) impregnated or grafted porous solid sorbents have gained significant interest as promising carbon capture materials in recent years. However, high synthesis cost, limited CO₂ adsorption capacity, slow desorption kinetics, and poor cycling stability remain a challenge to overcome before their practical implementation.

In this Example, natural silk fibroin was evaluated as a potential material for low-cost carbon capture technology. We synthesized solid and porous support-free porous silk-nanoparticles (SNP) and silk-fibroin aerogel from the natural mulberry silk cocoon and studied its CO₂ adsorption performance. The mulberry silk fibroin is a natural blend of amino acids, containing glycine (45.9%), alanine (30.30%), serine (12.1%), tyrosine (5.3%), valine (1.8%), threonine (0.9%), and other amino acids (3.7%). Silk has shown promising performance in a wide range of applications due to its low cost, biodegradability, eco-friendly nature and diverse functional properties. In addition, silk exhibits unique properties such as lightweight, high temperature stability and hydrophobicity, which could be particularly beneficial for CO₂ capture applications.

The silk-fibroin aerogel prepared from the mulberry silk demonstrated a high CO₂ adsorption capacity (~3.8 mmol CO₂/gm sorbent at 0.15 atm CO₂ pressure and 5° C.), which is comparable to the state-of-the-art solid sorbents and higher than those based on amino acids. The SNP and aerogel have a low differential heat of adsorption (ΔH_{ads}) similar to the state-of-the-art solid sorbents, suggesting that silk-fibroin-based sorbent can be regenerated using low-temperature heating, which is essential for cost-effective carbon removal. The aerogels also show better cycling stability than pure amino acids and AAILs. In addition, the SNP demonstrates excellent thermal stability up to 250° C. Overall, this Example establishes that SNP and silk-fibroin aerogel derived from natural silk exhibits superior CO₂ sorption properties.

### Materials and Methods

Synthesis of Silk Nanoparticles and Silk-Fibroin Aerogel from Raw Silk Cocoon

To prepare the silk-fibroin based CO₂ sorbent we first attempted to prepare silk-fibroin nanoparticles by partial acid hydrolysis. A schematic of the synthesis process is represented in FIG. 1. At first, mulberry silk cocoons were cut into small pieces and boiled in a 0.05 M Na₂CO₃ aqueous solution (100° C.) for 30 min (i). After removing the outer sericin layer by boiling, the silk was washed with cold water several times and the degummed silk was dried in air. In the hydrolysis method, 0.25 μm of degummed silk was taken in a 100 ml glass beaker and 40 ml of 5 weight % H₂SO₄ solution was added into it. Then the beaker was placed on a hot plate and heated to 75° C. During the acid hydrolysis process the surrounding temperature and humidity were 20-22° C. and 35-40%, respectively (ii). The silk dispersion was continuously stirred using a magnetic stirrer while heating. The H₂SO₄ weight % in the solution was increased to 15% (7.5, 10, 12.5 and 15%) in 4 steps by adding the equal amount of 98 weight % H₂SO₄ at 5 minutes interval. The solution was stirred on the hot plate for an additional 40 min. Then, the solution was placed on a sonicator bath preheated to 55° C. and sonicated for 1 hour (iii). After that, the dispersed silk was separated from the acid by centrifugation at 10000 rpm for 3 min (iv). The separated silk was taken in a glass beaker with 10 ml of water and neutralized using 0.5 M NaOH solution (v). Then the silk fibroin was washed 3 times with DI water using centrifugation at 10000 rpm for 3 min to remove the salt generated from the acid neutralization (vi). The cleaned silk was then dispersed in water again and placed in a sonicator bath for 30 min at room temperature (vii). After sonication, the dispersion was frozen at −80° C. Finally, the frozen dispersion was lyophilized at −48° C. to obtain the SNP (vii-ix).

The yield of silk-fibroin nanoparticles prepared by this method was limited. Additionally, the performance of the nanoparticles was limited due to the difficulty in controlling the porosity and specific surface area of the SNP. To further enhance the CO₂ adsorption performance of silk-firoin, we adopted silk-fibroin aerogel preparation using aqueous silk-fibroin solution. The schematic of the silk-fibroin aerogel preparation from the Bombyx mori silk cocoon is represented in FIG. 2. At first, mulberry silk cocoons were cut into small pieces and boiled in a 0.05 M Na₂CO₃ aqueous solution for 30 min and washed with DI water (i). The degumming of silk using 0.05 M Na₂CO₃ solution was repeated one more time. After removing the outer sericin layer by boiling, the silk was washed with cold water several times, and the degummed silk was dried in the air. The dried silk fibroin was dissolved in a warm aqueous 9.3 M LiBr solution at 65° C. and stirred for 6 hours (ii). Then the silk-fibroin solution was dialyzed in a cellulose tube (molecular weight cut-off ~3.5 kDa) against a water medium to remove the LiBr salt from the aqueous silk-fibroin solution at 4° C. (iv). To determine the weight percentage of silk fibroin in the solution, a small amount of measured solution was dried in an oven to evaporate the water, and the weight of the silk fibroin was measured to determine the weight percentage of silk fibroin in the solution. The weight percentage of the silk-fibroin in the dialyzed solution was adjusted by adding water as required. The prepared silk fibroin solution was stored in an airtight plastic container at room temperature. The solution generally takes 2 to 3 weeks to form the silk-fibroin hydrogel. However, we observed that silk-fibroin solution only forms hydrogel by this time when its weight percentage is above 0.2%. However, the jellification process time can be reduced to several hours, and low solution concentration may be effective for gel preparation by applying CO₂ gas at 100 bars at 40° C. (Marin et al. “Silk Fibroin Aerogels for Drug Delivery Applications.” J. Supercrit. Fluids. 2014, 91, 84-89).

To prepare the silk-fibroin nanostructures, the silk-fibroin solution and hydrogel were frozen at 193 K (in a refrigerator) and 77 K (using liquid nitrogen), respectively (vi). The frozen silk fibroin solution and hydrogel were then lyophilized at −48° C., yielding silk-fibroin aerogel (vii). For silk-fibroin aerogel preparation via CO₂ critical point drying, 5 mL of 1 wt % silk fibroin hydrogel underwent sequential dehydration using ethanol solutions of 20, 30, 50, 70, 80, 90, and 100%. The fully dehydrated ethanol-treated silk-fibroin gel was then subjected to CO₂ critical point drying to obtain the final aerogel.

### Characterization

Room temperature X-ray diffraction (XRD) patterns of the degummed silk, SNP, sol-0.06%@77K and gel-0.25%@77K were studied using a Cu-Kα X-ray diffractometer (Bruker D8 Discovery). Field emission scanning electron microscopy (FESEM) images were collected using a scanning electron microscope (SEM, Model: Zeiss 1530). Atomic force microscopy (AFM) measurement was performed using a Bruker Dimension Icon AFM. Thermo Al-Kα X-ray photoelectron spectrometer was used for the X-ray photoemission spectroscopy (XPS) study of the air exposed SNP. For the XPS, FESEM and AFM studies, samples were dispersed in water and drop casted on microscopic glass slides. After drop casting, the glass slides were heated in air at 90° C. for 15 min. The particle size measurement was performed using the aqueous SNP dispersion by a Zetasizer (Malvern Nano ZSP). Total nitrogen and carbon content in the degummed silk and SNP was measured using combustion elemental analyzer (Thermo Flash EA 1112). The room temperature Fourier Transform Infrared Spectroscopy (FTIR) was studied in ambient atmosphere using FTIR spectrometer (Thermo Fisher Scientific: Nicolet iS10). To study the FTIR spectra of SNP before CO₂ adsorption, it was heated in an oven at 95° C. for 30 min to desorb chemisorbed CO₂ occurred during air exposure, and instantly dispersed in hot water (95° C.) to avoid CO₂ adsorption before FTIR measurement. To study the FTIR spectra of SNP after CO₂ adsorption, air exposed samples were dispersed in water, and its FTIR spectra were studied, and the obtained spectrum was similar to that of air exposed SNP measured in air. For Raman spectroscopy analysis, the gel-0.25%@77K aerogel sample was exposed to a CO₂ atmosphere before measurement and sealed in CO₂ environment, while the other sample was heated at 90° C. for 30 minutes to desorb any captured CO₂ and sealed in CO₂ free environment. The thermogravimetry analysis of the silk-fibroin-based sorbents was studied from room temperature to 575° C. in O₂, N₂ and CO₂ gas environment using thermogravimeter (Model TGA Q550). Nitrogen adsorption desorption measurements were carried out at 77 K using a Quantachrome (Model: autosorb iQ7) instrument. The specific surface area of the sorbents was measured by the Brunauer-Emmett-Teller (BET) method. The pore size distribution of the samples was estimated using the nonlocal density functional theory (NLDFT) approach.

### CO₂ Adsorption and Desorption Measurement

CO₂ adsorption desorption isotherms of SNP and aerogels were studied using a Quantachrome (Model: autosorb iQ 7) instrument. The temperature of the sample cell was controlled using a liquid bath temperature controller (Model JULABO 200F). The multi-cycle stability of the aerogel sol-0.06%@77K and gel-0.25%@77K was studied by studying the CO₂ adsorption desorption isotherms at 5° C. using the same Quantachrome (Model: autosorb iQ 7) instrument. The sample was heated in a vacuum at 100° C. for 30 min before each CO₂ adsorption-desorption isotherm measurement. To study the multi-cycle moisture stability, the aerogel prepared using the lyophilization of silk-fibroin hydrogel (0.25 wt %) was exposed overnight to 90% relative humid air at 22° C.; the next day, it was outgassed by vacuum heating at 100° C. for 30 min before the CO₂ adsorption-desorption isotherms measurement. The CO₂ adsorption capacity at 0.15 atm and 5° C. was monitored to study the stability of the aerogels.

To study CO₂ desorption kinetics, first, the CO₂ adsorption was performed by keeping the gel-0.25%@77K aerogel in 1 atm CO₂ gas environment at 23° C. for 15 minutes. Its mass change was then measured in 1 atm CO₂ environment at 60° C. using TGA.

To study the adsorption kinetics and understand the adsorption capacity in humid gas, the gel-0.25%@77K aerogel was loaded in a U-shaped quartz tube, and ~13.3% CO₂ balanced N₂ gas was passed through the U-tube and the output gas from the adsorption-desorption tube was analyzed using gas chromatography (GC, Inficon Micro GC Fusion). For the study, first, the U-shaped tube was dipped in a 60° C. water bath for 10 minutes to desorb any adsorbed CO₂ gas. After that, the U-bend tube was transferred to a water bath at 5° C. and kept at 5° C. for ~10 minutes. After the CO₂ adsorption step, the tube was transferred to the 60° C. water bath. During this adsorption-desorption cycle, the gas concentration in the outlet of the sample tube was monitored using the GC. To study the CO₂ adsorption kinetics in the presence of humidity, the dry gas mixture was first passed through two conical flasks containing water to gain moisture. The relative humidity in the gas stream was measured using a humidity meter. The relative humidity in the gas stream at 5° C. was 83±2%. The humid gas was passed through the sample tube, and adsorption kinetics was studied. To study the desorption kinetic, after adsorption, the gas in the tube was switched to the dry gas again, and the U-bend tube was transferred to the hot water bath at 60° C. to study desorption kinetics using dry gas.

### Results and Discussion

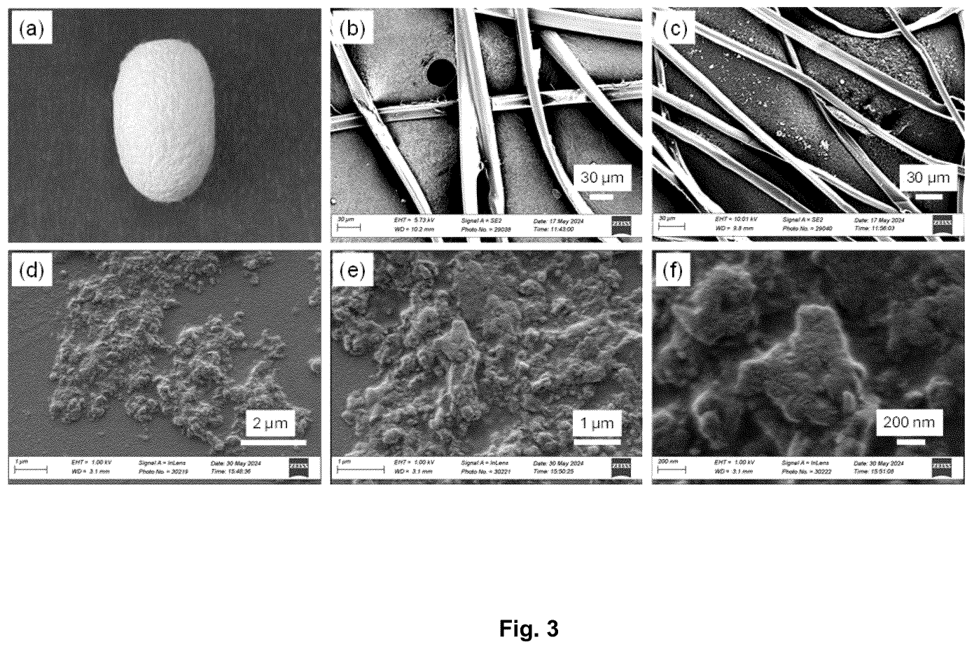

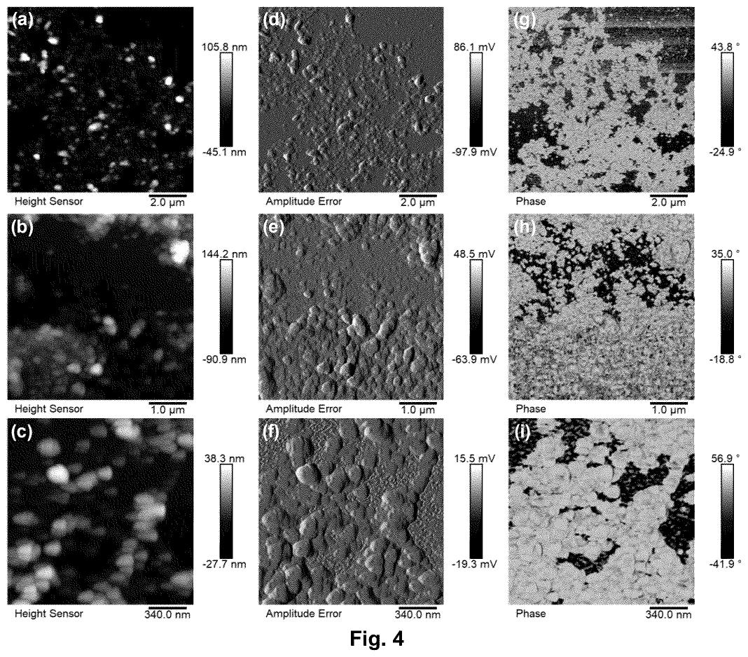

The SNP was prepared from the mulberry silk cut cocoons using the partial acid hydrolysis method and a schematic of the synthesis process is represented in FIG. 1. The optical images of silk cocoon, raw silk fiber, degummed silk fiber/silk fibroin, and FESEM images of the SNP are shown in FIG. 3. The average diameter of the raw silk fiber (20 micron) is reduced to 15 microns after removing the outer sericin layer in the degummed silk. The FESEM images and the AFM images (FIG. 4) confirm the submicron silk particle size.

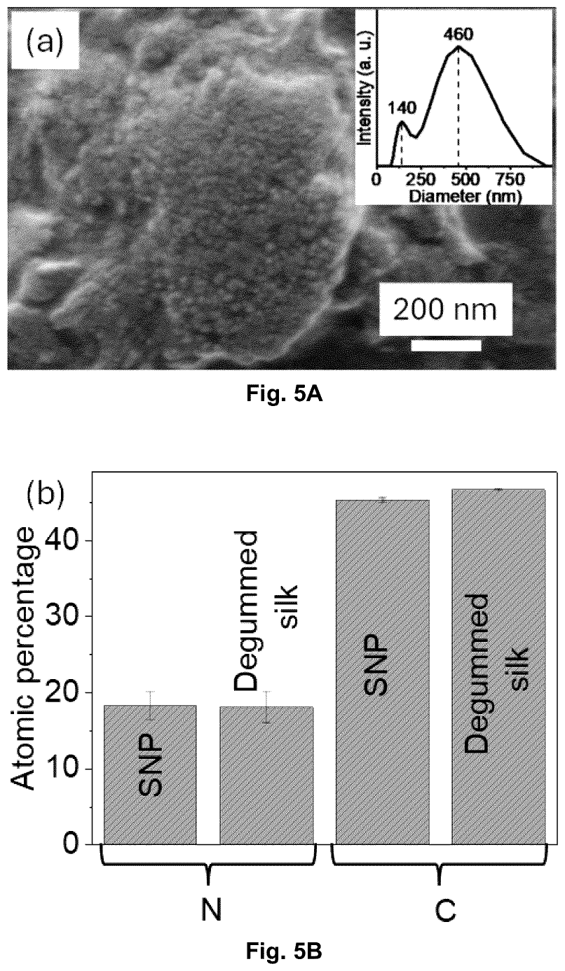

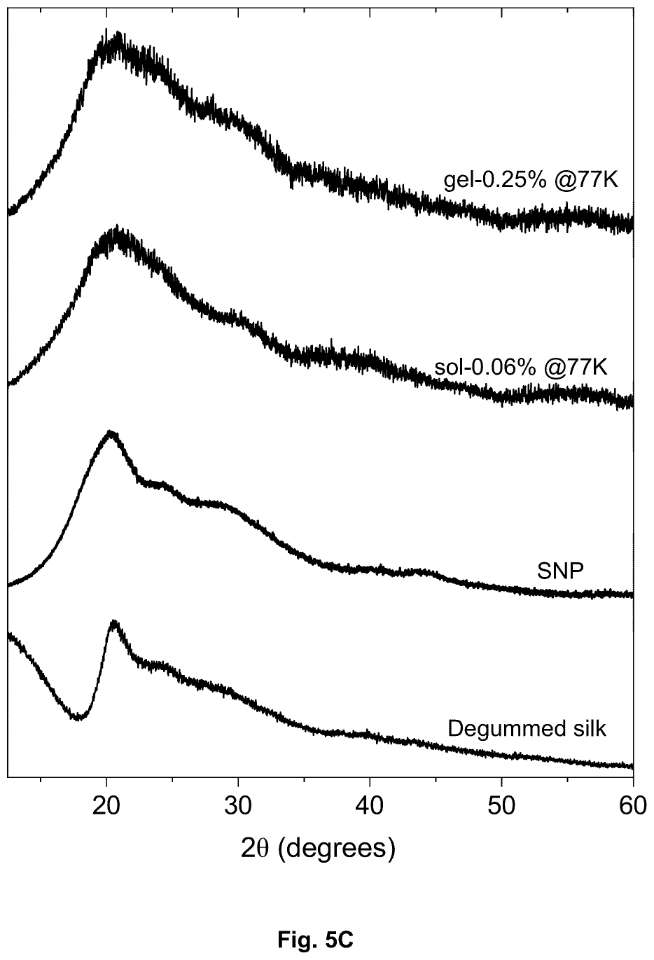

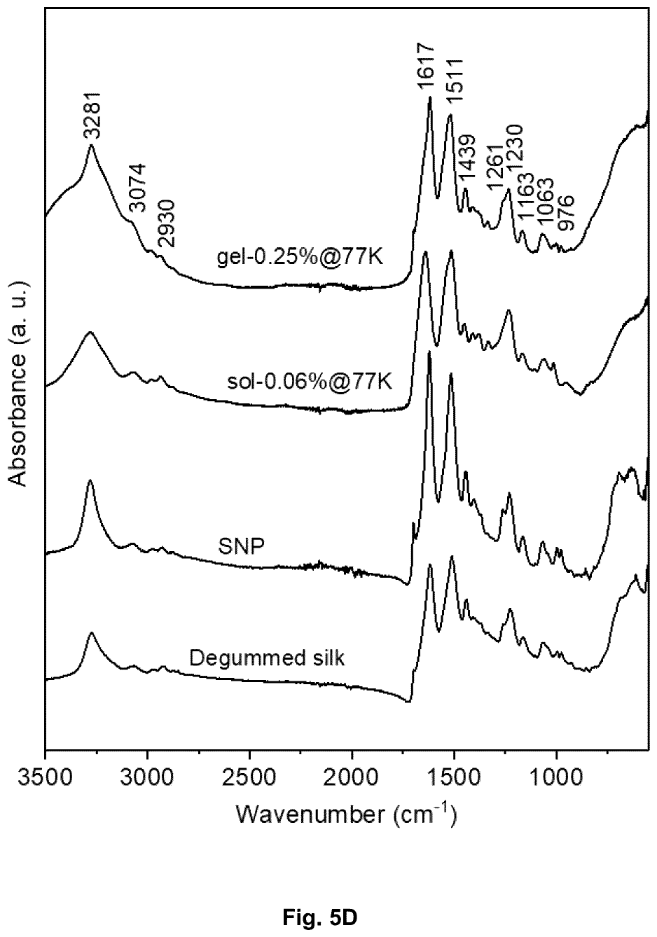

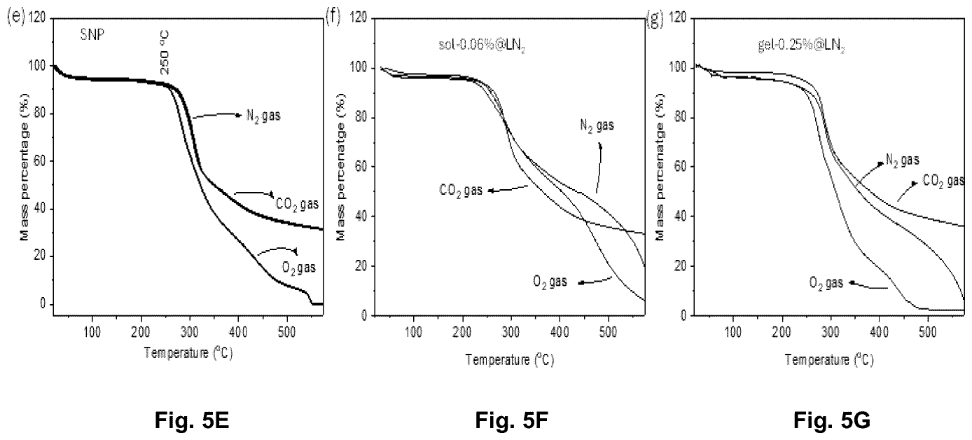

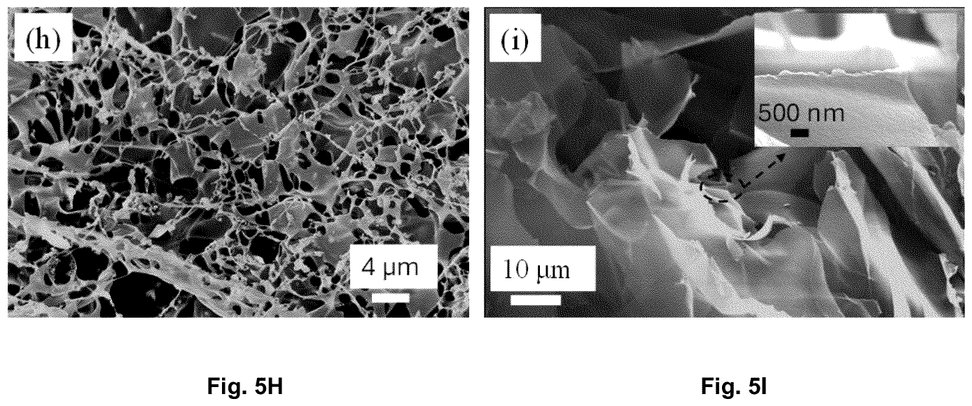

FIG. 5A represents the high resolution FESEM image with the roughness and porosity visible on SNP sample surface. The particle size distribution was measured using Zetasizer and presented in the inset. The plot reveals the presence of two distinct particle sizes of 140 and 460 nm in average diameter. FIG. 5B represents the bulk C and N content in the SNP and degummed silk, which reveals that N/C ratio in both samples remained almost unchanged, only a slight increment in the N/C ratio was observed in SNP, suggesting a small enrichment of amine groups which could be helpful for enhancing CO₂ adsorption.

FIG. 5C shows the room temperature X-ray diffraction (XRD) patterns of the degummed silk, SNP, and aerogels. Silk fibroin has two main crystalline structures, Silk I and Silk II (Xing et al. “Robust and Flexible Smart Silk/PEDOT Conductive Fibers as Wearable Sensor for Personal Health Management and Information Transmission.” Int. J. Biol. Macromol. 2023, 248, 125870). The main peaks at 2θ~20.3° and 28.5° represent the presence of silk I structure, while the peak at 2θ~24.3° belongs to the silk II structure. The degummed silk shows higher background intensity below 2θ~19° which could be due to the presence of a significant amount of amorphous silk phase. The acid hydrolysis process removes this amorphous phase from the silk fibroin and the removal of this amorphous silk phase from silk fibroin structure may instigate the formation of crystalline porous SNP. The lyophilization of the silk solution and hydrogel also instigates the formation of higher crystalline silk-fibroin aerogel. The low background intensity at angle below 2θ~19° of the sorbent's XRD data confirms its higher crystalline nature. However, the sorbents do not show any significant change in the XRD peak positions with respect to the degummed silk, suggesting that the crystal structure of silk fibroin remained unaffected after acid hydrolysis and lyophilization.

FIG. 5D shows the FTIR spectra of the degummed silk and the silk-fibroin-based sorbents. There is no significant difference in the peak positions. The FTIR spectra of FIG. 5D shows the absorption peaks at 3281, 3074, 2930, 1617, 1511, 1439, 1261, 1230, 1163, 1063, 976 and 693 cm⁻¹. The peaks at 3281 and 3074 cm⁻¹ are associated with the N—H symmetric and antisymmetric stretching mode vibration of the amine groups. The peak 2930 cm⁻¹ is mainly associated with the aliphatic C—H stretching. The broad and intense peak at 1617 cm⁻¹ is due to the bending vibration of N—H bond overlapped with the carbonyl bond C—O. The peak at 1511 cm⁻¹ represents the combination of the C—N stretching mode vibration and N—H bending mode vibration in amide II. The peak at 1439 is associated with the bending vibration of CH₃ in glycine and alanine. The peak at 1165 cm⁻¹ is caused by the C—N stretching in tyrosine. The C—N stretching vibration of glycine appears at 1063 cm⁻¹ which also overlaps with to the C—O bond stretching vibration mode of —OH group. The peak at 693 cm⁻¹ is associated with the at COO bending. Overall, the FTIR spectra shows the presence of amino and carboxyl groups and suggests the presence of amino acids such as glycine and alanine in the sorbents. As with XRD and bulk N/C ratio, FTIR suggests that the crystal structure of silk remains unchanged after acid hydrolysis or lyophilization of the aqueous solution/hydrogel. However, the crystallinity of the sorbents increases as compared to the degummed silk.

Thermal stability of the synthesized silk-fibroin sorbents was examined in N₂, CO₂ and O₂ gas environment using thermogravimetry, as represented in FIGS. 5E-5G. The study confirms that the synthesized sorbents are stable up to 250° C. in inert N₂ and CO₂ gas environment. However, the thermal degradation of silk starts at slightly lower temperature in highly oxidizing condition of pure O₂. Overall, the TGA analysis confirms robust thermal stability of the synthesized silk-fibroin-based sorbents. CO₂ desorption at temperatures below 200° C. is not expected to cause material degradation.

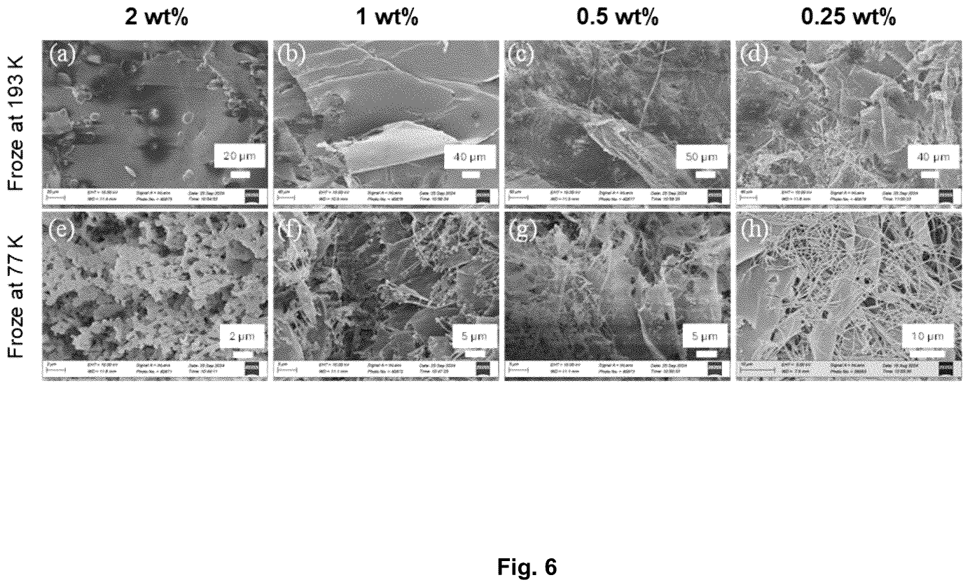

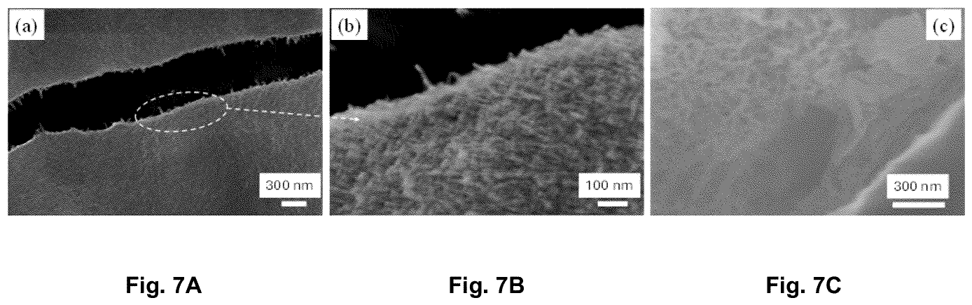

FIG. 5H shows the FESEM image of the silk-fibroin aerogel prepared using the lyophilization of the 0.06 wt % solution froze at 77 using liquid nitrogen. This sample is mentioned as sol-0.06%@77K in the rest of the disclosure. FIG. 5H reveals the formation of nanowires along with some nanosheets. In contrast, the aerogel prepared using lyophilization of the 0.25 wt % hydrogel froze at 77 K using liquid nitrogen demonstrates only nanosheets like structures as represented in FIG. 5I. This aerogel sample is mentioned as the gel-0.25%@77K in the rest of the disclosure. We studied the effect of freezing conditions on the aerogel morphology using different silk-fibroin solutions (2, 1, 0.5 and 0.25 wt %) as represented in FIG. 6. We observed that lower solution concentration and faster freezing rate render the formation of nano-sheets with higher specific surface area. The lower freezing temperature using liquid nitrogen inhibits the nucleation process and prevents the formation of larger structures during the freezing process, thereby giving nanosheet like structures. For the same reason, hydrogel, where silk-molecular chain has lower mobility than in solution cannot nucleate to form larger structures, resulting in nanostructures with higher surface area than the solution-based aerogel prepared using same concentration and freezing technique. FIGS. 7A and 7B represent the high resolution FESEM images of silk-nano sheets like structure in aerogel gel-0.25%@77K. The nanosheets which have a thickness of less than 50 nm are composed of nano silk-fibroin of diameter around 5-10 nm, suggesting its high specific surface area. The aerogel prepared using CO₂ critical point drying also demonstrated nano-fiber structures (FIG. 7C).

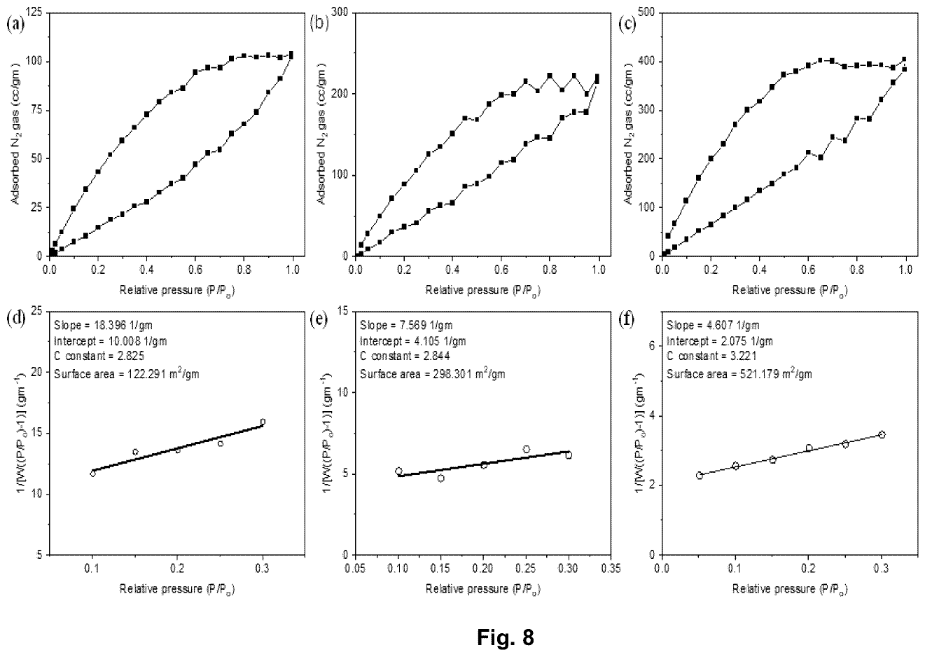

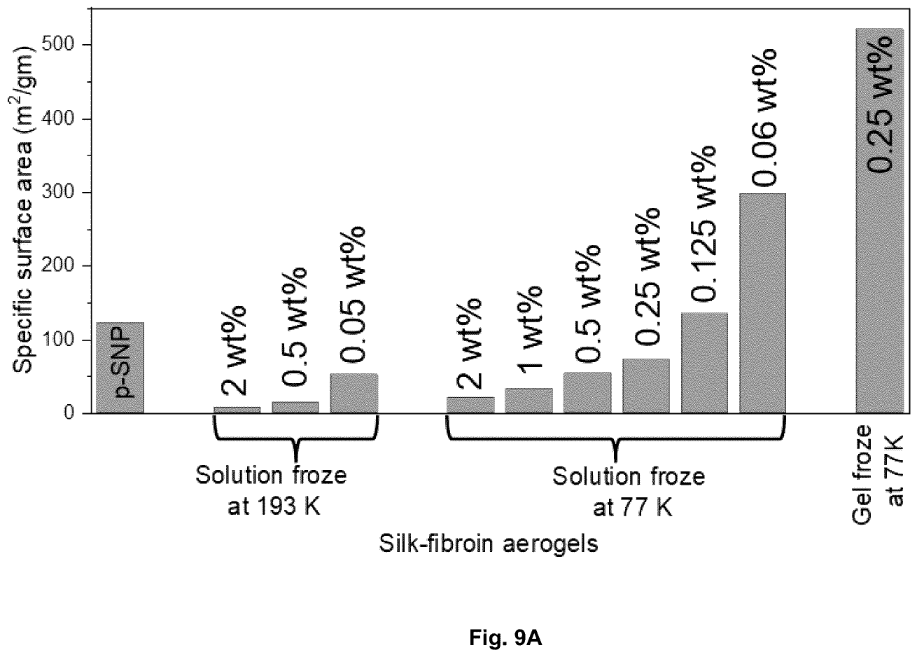

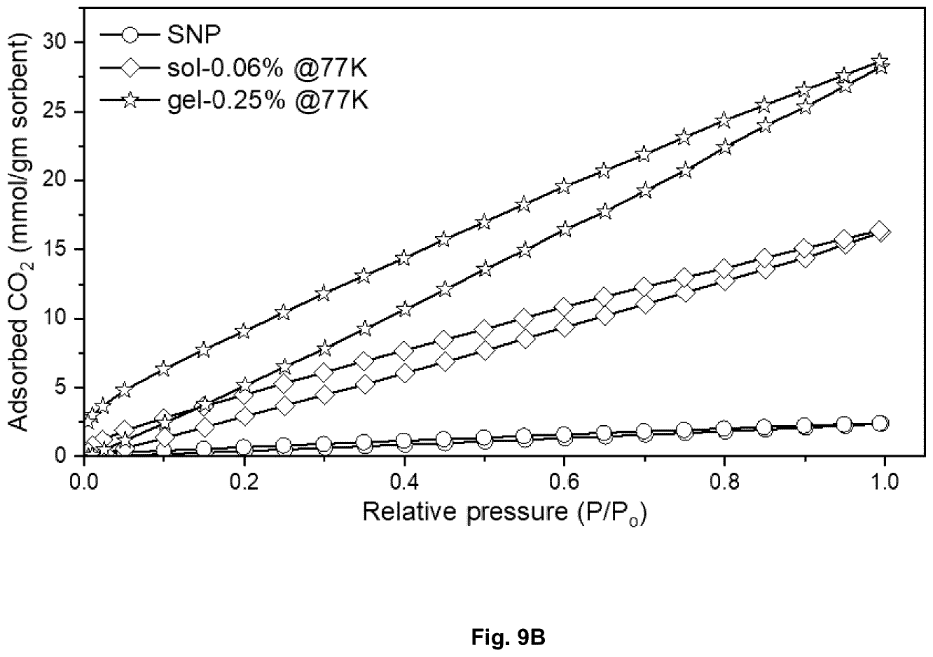

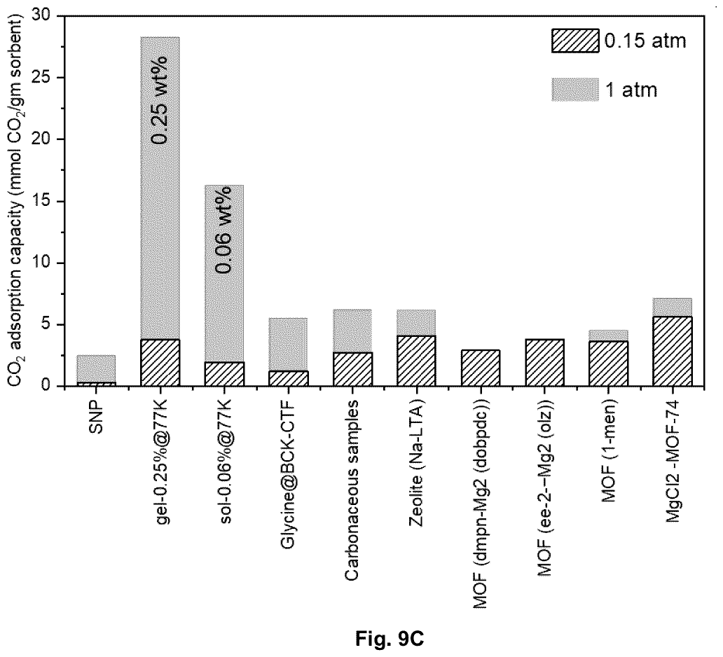

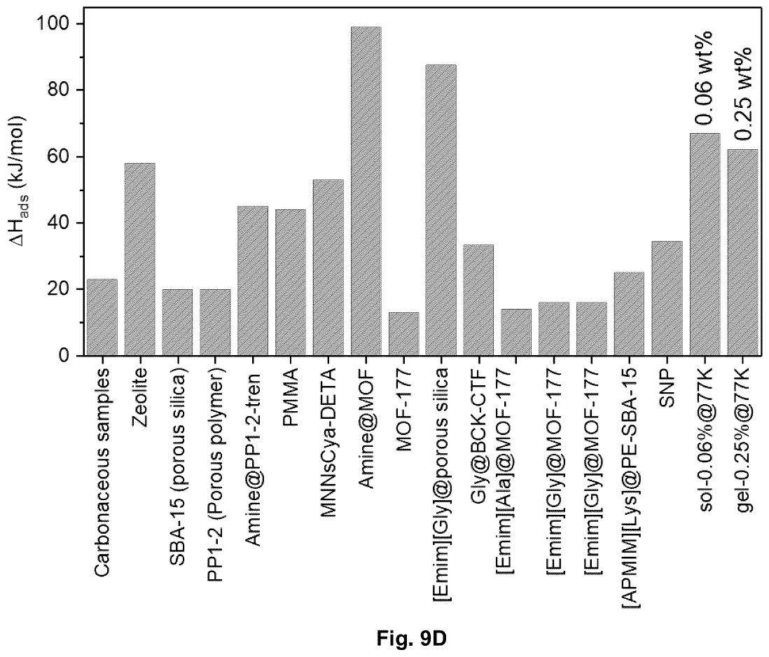

The specific surface area was measured using the Brunauer-Emmett-Teller (BET) method and porosity of the SNP, sol-0.06%@77K and gel-0.25%@77K were determined by DFT approximation using the N₂ adsorption isotherm at 77 K as represented in FIG. 8. N₂ adsorption isotherm analysis reveals a specific surface area of 122.3 m²/gm with effective pore volume of 0.15 cc/gm. While aerogel sol-0.06%@77K and gel-0.25%@77K showed a specific surface area of 298 and 521 m²/gm, respectively. We also measured the specific surface area of the aerogel prepared using the silk-fibroin solution and hydrogel froze using liquid nitrogen or refrigerator, and comparison of their specific surface area is represented in FIG. 9A. The aerogel prepared using 0.25 wt % hydrogel and the aerogel prepared using 0.06 wt % solution demonstrated a high surface area compared to the SNP.

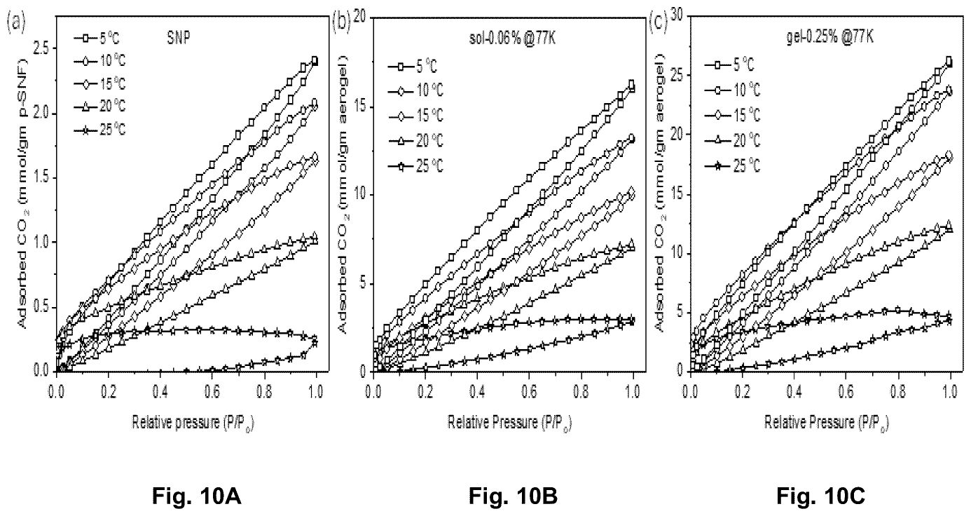

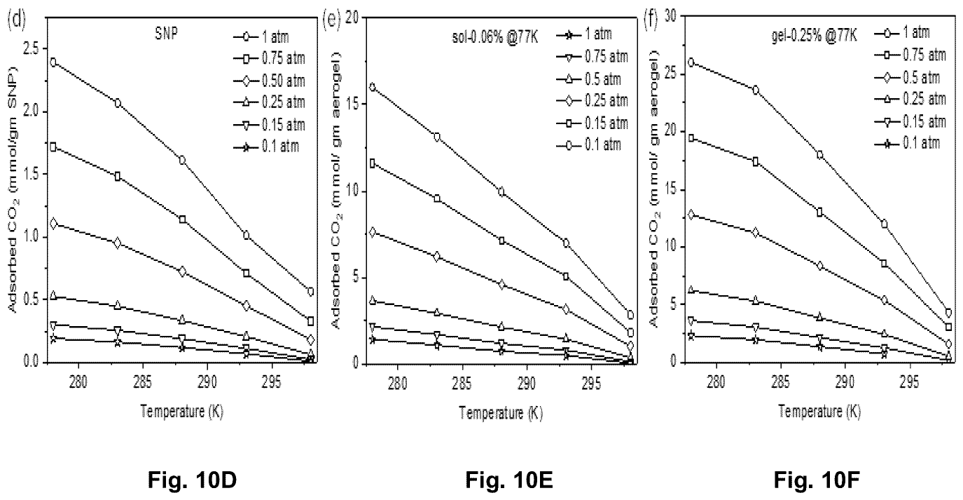

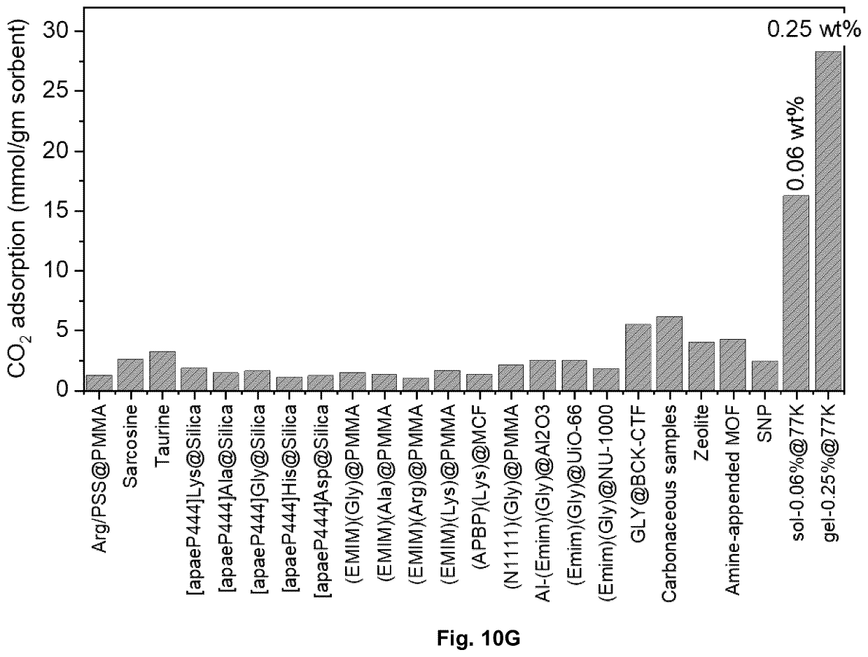

The CO₂ adsorption capacity was measured using CO₂ adsorption-desorption isotherms at a temperature ranging from 5 to 30° C. as demonstrated in FIGS. 10A-10C. FIGS. 10D-10F represents the CO₂ adsorption capacity as a function of temperature and pressure, determined from CO₂ adsorption desorption isotherms of the SNP, sol-0.06%@77K and gel-0.25%@77K. The CO₂ adsorption capacity gradually decreases as the temperature increases and becomes negligible after 30° C. The temperature dependence of CO₂ adsorption capacity follows a similar trend at CO₂ pressures from 0.1 atm to 1 atm. The measured CO₂ adsorption capacity at 5° C. is 2.4 mmol CO₂/gm for SNP at 1 atm CO₂ pressure. However, the silk-fibroin aerogels demonstrated much higher CO₂ adsorption capacity than SNP as represented in FIG. 9B.

The adsorption capacity of SNP and aerogels at 1 atm CO₂ is higher than the reported amino acid-based sorbents including AAILs, many of which are specifically synthesized with increased number of —NH₂ group in the molecular chain to enhance CO₂ adsorption (FIG. 10G and Table 1). The high CO₂ adsorption capacity of the silk-fibroin-based sorbents may be attributed to its large surface area and the presence of abundant-NH₂ group on its surface. FIG. 9C represents a comparison of the CO₂ adsorption capacity of the SNP and aerogels with the state-of-the-art CO₂ sorbents. The comparison reveals silk-fibroin aerogel has a comparable capacity at 0.15 atm CO₂ pressure with other high performing materials, except metal-organic framework (MgO₂-MOF-77). However, the natural availability, low cost, facile synthesis, and biocompatibility of silk make the silk-fibroin aerogel a better candidate than other materials for CO₂ adsorption.

TABLE 1
Comparison of the CO₂ adsorption capacity of SNP and aerogels with other high
performing amino acids and AAILs based sorbents reported at nearly similar conditions.

| | | | Effective | | | |
|---|---|---|---|---|---|---|
| | Porous | | surface | Reported | | |
| | solid | wt | area | adsorption | Adsorption | |
| AAs/AAILs | support | % | (m²/gm) | condition | capacity | References |
| SNP | No support | — | 122 | 1 bar pure | 2.4 | This |
| | | | | CO₂, 5° C. | | Example |
| sol-0.06% @ | No support | — | 298 | 1 bar pure | 16.4 | This |
| 77K | | | | CO₂, 5° C. | | Example |
| gel-0.25% @ | No support | — | 521 | 1 bar pure | 28.6 | This |
| 77K | | | | CO₂, 5° C. | | Example |
| Egg white | Activated | 10 | 625 | 1 bar pure | 0.57 | [1] |
| | Carbon | | | CO₂, 25° C. | | |
| [APMIM][Lys] | Silica | 50 | 148 | 1 bar pure | 0.55 | [2] |
| | | | | CO₂, 30° C. | | |
| [APMIM][Lys] | PMMA | 50 | 88 | 1 bar pure | 1.45 | [2] |
| | | | | CO₂, 30° C. | | |
| [EMIM][Gly] | UiO-66 | 5 | 1102 | 1 bar pure | 2.5 | [3] |
| | (MOF) | | | CO₂, 25° C. | | |
| [EMIM][Gly] | NU-1000 | 5 | 1754 | 1 bar pure | 1.8 | [3] |
| | (MOF) | | | CO₂, 25° C. | | |
| Arg/PSS | PMMA | 25 | — | 1 bar pure | 1.3 | [4] |
| | | | | CO₂, 40° C. | | |
| [N1111][Gly] | PMMA | 50 | 28 | 1 bar 10% | 2.14 | [5] |
| | | | | CO₂, 35° C. | | |
| [EMIM][Gly] | Alumina | 16 | 83 | 1 bar 15% | 2.53 | [6] |
| | | | | CO₂, 30° C. | | |
| Sarcosine | No support | — | — | 1 bar pure | 2.63 | [7] |
| | | | | CO₂, 30° C. | | |
| Taurine | No support | — | — | 1 bar pure | 3.25 | [7] |
| | | | | CO₂, 30° C. | | |
| [apaeP444][Lys] | Silica | 50 | 150 | 1 bar pure | 1.87 | [8] |
| | | | | CO₂, 30° C. | | |
| [apaeP444][Ala] | Silica | 50 | — | 1 bar pure | 1.46 | [8] |
| | | | | CO₂, 25° C. | | |
| [apaeP444][Gly] | Silica | 50 | 137 | 1 bar pure | 1.46 | [8] |
| | | | | CO₂, 25° C. | | |
| [apaeP444][His] | Silica | 50 | — | 1 bar pure | 1.46 | [8] |
| | | | | CO₂, 25° C. | | |
| [apaeP444][Asp] | Silica | 50 | — | 1 bar pure | 1.46 | [8] |
| | | | | CO₂, 25° C. | | |
| [EMIM][Gly] | PMMA | 50 | — | 1 bar pure | 1.53 | [9] |
| | | | | CO₂, 40° C. | | |
| [EMIM][Ala] | PMMA | 50 | — | 1 bar pure | 1.38 | [9] |
| | | | | CO₂, 40° C. | | |
| [EMIM][Arg] | PMMA | 50 | — | 1 bar pure | 1.01 | [9] |
| | | | | CO₂, 40° C. | | |
| [EMIM][Lys] | PMMA | 50 | 27 | 1 bar pure | 1.67 | [9] |
| | | | | CO₂, 40° C. | | |

Abbreviations:
[APMIM][Lys] = 1-aminopropyl-3-methylimidazolium lysine;
PSS = polystyrene sulfonate;
[N₁₁₁₁][Gly] = tetramethylammonium glycinate;
[apaeP444][AA] = N-(3-aminopropyl)aminoethyl tributylphosphonium amino acid salt.

### REFERENCES

[1] Hatta et al. “Enhancing Surface Functionalization of Activated Carbon Using Amino Acids from Natural Source for CO₂ Capture.” Sep. Purif. Technol. 2023, 313, 123468.
[2] Huang et al. “Evaluation of Supported Multi-Functionalized Amino Acid Ionic Liquid-Based Sorbents for Low Temperature CO₂ Capture.” Fuel. 2022, 310, 122284.
[3] Xia et al. “Understanding Reduced CO₂ Uptake of Ionic Liquid/Metal-Organic Framework (IL/MOF) Composites.” ACS Appl. Nano Mater. 2019, 2, 6022.
[4] Jiang et al. “Development of Amino Acid and Amino Acid-Complex Based Solid Sorbents for CO₂ Capture.” Appl. Energy. 2013, 109, 112.
[5] Ren et al. “Supported Ionic Liquid Sorbents for CO₂ Capture from Simulated Flue-Gas.” Chin. J. Chem. Eng. 2018, 26, 2377.
[6] Balsamo et al. “Post-Combustion CO₂ Capture: On the Potentiality of Amino Acid Ionic Liquid as Modifying Agent of Mesoporous Solids.” Fuel. 2018, 218, 155.
[7] Chatterjee et al. “Adsorption of Carbon Dioxide on Naturally Occurring Solid Amino Acids.” J. Environ. Chem. Eng. 2016, 4, 3170.
[8] Ren et al. “Preparation and CO₂ Sorption/Desorption of N-(3-Aminopropyl)Aminoethyl Tributylphosphonium Amino Acid Salt Ionic Liquids Supported into Porous Silica Particles.” Ind. Eng. Chem. Res. 2012, 51, 7901.
[9] Wang et al. “Amino Acid-Functionalized Ionic Liquid Solid Sorbents for Post-Combustion Carbon Capture.” ACS Appl. Mater. Interfaces. 2013, 5, 8670.

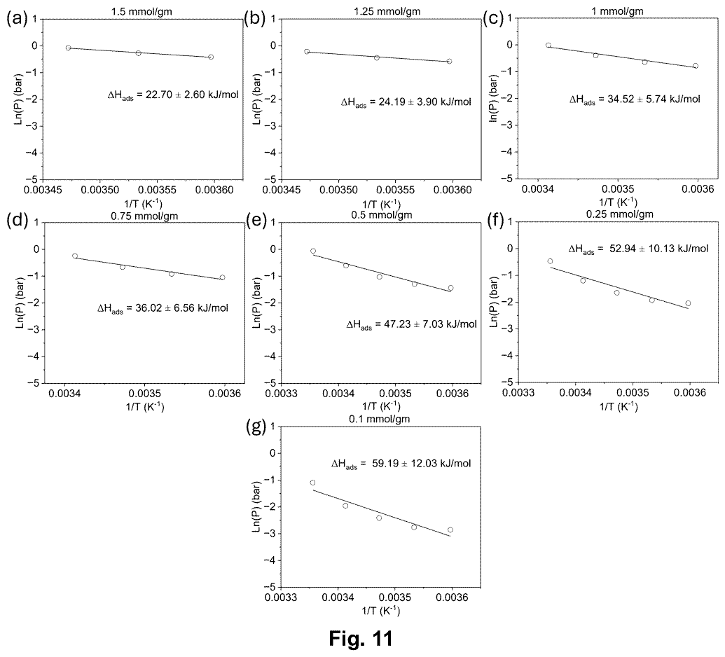

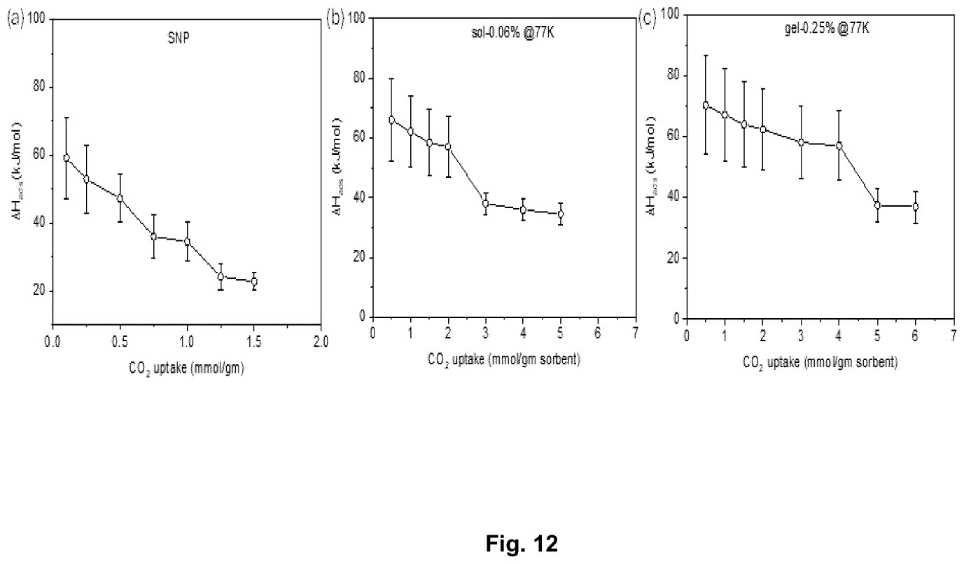

The differential adsorption enthalpy (ΔH_{ads}), which is an important sorbent parameter for a quantitative understanding of the thermal energy consumption required for the sorbent regeneration, was determined from Clausius-Clapeyron relationship using experimental isotherm data (FIG. 11) using method known in the art (Kim et al. “Cooperative Carbon Capture and Steam Regeneration with Tetraamine-Appended Metal-Organic Frameworks.” Science. 2020, 369, 392). FIG. 12 represents the ΔH_{ads} dependence of the CO₂ adsorption capacity of SNP, sol-0.06%@77K and gel-0.25%@77K, revealing the heterogeneity of surface energy and chemical interaction between the adsorption sites as the adsorption capacity is increased. The higher ΔH_{ads} at lower capacity suggest that chemisorption is dominant mechanism, followed by the physisorption, as the available amine groups become saturated at higher CO₂ adsorption capacity. The SNP and aerogel obtained from 0.06 wt % solution and 0.25 wt % hydrogel show a 4H_{ads} value of 34.52, 67.15 and 62.16 kJ/mol, respectively, at 1 mmol of CO₂/gm capacity, which is comparatively lower than reported 4H_{ads} of the state-of-the-art solid sorbents at 1 mmol of CO₂/gm capacity, as represented in FIG. 9D and Table 2. The obtained ΔH_{ads} value of SNP is comparable to glycine (one of the primary silk fibroin components) based solid sorbents (33.3 kJ/mol) (Dong et al. “Post Synthesis of a Glycine-Functionalized Covalent Triazine Framework with Excellent CO₂ Capture Performance.” Microporous Mesoporous Mater. 2020, 306, 110475). The relatively low ΔH_{ads} of SNP contributes to its superior CO₂ adsorption performance near room temperature and offers an advantage for rapid CO₂ desorption at lower temperatures, thereby reducing energy consumption during cyclic adsorption and desorption process via temperature swing.

TABLE 2
Comparison of differential adsorption enthalpy (ΔH_{ads}) of
silk-fibroin-based sorbent with other state-of-the-art sorbents reported
at 1 mmol CO₂/gm sorbent adsorption capacity.

| | Differential | |
|---|---|---|
| | adsorption | |
| | enthalpy | |
| | (ΔH_{ads}) | |
| Sorbents | (−kJ/mol) | References |
| SNP | 34.5 | This Example |
| sol-0.06%@77 K | 67.15 | This example |
| gel-0.25%@77 K | 62.16 | This example |
| Carbonaceous samples | 23 | [1] |
| Zeolite | 58 | [2] |
| SBA-15 (porous silica) | 20 | [3] |
| PP1-2 (Porous polymer) | 20 | [4] |
| Amine@PP1-2-tren (Amine modified | 45 | [4] |
| porous polymer) | | |
| PMMA | 44 | [5] |
| MNNsCya-DETA (polyamine- | 53 | [6] |
| appended, cyanuric acid-stabilized | | |
| melamine) | | |
| Amine@MOF (tetraamine-appended | 99 | [7] |
| metal-organic frameworks) | | |
| MOF-177 (metal-organic frameworks) | 13 | [8] |
| [Emim][Gly]@porous silica | 87.7 | [9] |
| Gly@BCK-CTF (glycine-functionalized | 33.3 | [10] |
| covalent triazine framework) | | |
| [Emim][Ala]@MOF-177 | 14 | [8] |
| [Emim][Gly]@MOF-177 | 16 | [8] |
| [APMIM][Lys]@PE-SBA-15 | 25 | [5] |

References:
[1] Fan et al. “Chitosan Derived Nitrogen-Doped Microporous Carbons for High Performance CO₂ Capture.” Carbon. 2013, 61, 423.
[2] Bae et al. “Evaluation of Cation-Exchanged Zeolite Adsorbents for Post-Combustion Carbon Dioxide Capture.” Energy Environ. Sci. 2012, 6, 128.
[3] Mohamedali et al. “Imidazolium Based Ionic Liquids Confined into Mesoporous Silica MCM-41 and SBA-15 for Carbon Dioxide Capture.” Microporous Mesoporous Mater. 2020, 294, 109916.
[4] Xu et al. “Adsorption of CO₂ on a Micro-/Mesoporous Polyimine Modified with Tris(2-Aminoethyl)Amine.” J. Mater. Chem. A. 2015, 3, 16229.
[5] Huang et al. “Evaluation of Supported Multi-Functionalized Amino Acid Ionic Liquid-Based Sorbents for Low Temperature CO₂ Capture.” Fuel. 2022, 310, 122284.
[6] Mao et al. “A Scalable Solid-State Nanoporous Network with Atomic-Level Interaction Design for Carbon Dioxide Capture.” Sci. Adv. 2022, 8, eabo6489
[7] Kim et al. “Cooperative Carbon Capture and Steam Regeneration with Tetraamine-Appended Metal-Organic Frameworks.” Science. 2020, 369, 392.
[8] Philip et al. “Incorporation of Amino Acid-Functionalized Ionic Liquids into Highly Porous MOF-177 to Improve the Post-Combustion CO2 Capture Capacity.” Molecules. 2023, 28, 20 (2023).
[9] Sheshkovas et al. “Thermochemical Study of CO₂ Capture by Mesoporous Silica Gel Loaded with the Amino Acid Ionic Liquid 1-Ethyl-3-Methylimidazolium Glycinate.” Microporous Mesoporous Mater. 2022, 341, 112113.
[10] Dong et al. “Post Synthesis of a Glycine-Functionalized Covalent Triazine Framework with Excellent CO₂ Capture Performance.” Microporous Mesoporous Mater. 2020, 306, 110475.

### REFERENCES

[1] Fan et al. “Chitosan Derived Nitrogen-Doped Microporous Carbons for High Performance CO₂ Capture.” Carbon. 2013, 61, 423.
[2] Bae et al. “Evaluation of Cation-Exchanged Zeolite Adsorbents for Post-Combustion Carbon Dioxide Capture.” Energy Environ. Sci. 2012, 6, 128.
[3] Mohamedali et al. “Imidazolium Based Ionic Liquids Confined into Mesoporous Silica MCM-41 and SBA-15 for Carbon Dioxide Capture.” Microporous Mesoporous Mater. 2020, 294, 109916.
[4] Xu et al. “Adsorption of CO₂ on a Micro-/Mesoporous Polyimine Modified with Tris(2-Aminoethyl)Amine.” J. Mater. Chem. A. 2015, 3, 16229.
[5] Huang et al. “Evaluation of Supported Multi-Functionalized Amino Acid Ionic Liquid-Based Sorbents for Low Temperature CO₂ Capture.” Fuel. 2022, 310, 122284.
[6] Mao et al. “A Scalable Solid-State Nanoporous Network with Atomic-Level Interaction Design for Carbon Dioxide Capture.” Sci. Adv. 2022, 8, eabo6849
[7] Kim et al. “Cooperative Carbon Capture and Steam Regeneration with Tetraamine-Appended Metal-Organic Frameworks.” Science. 2020, 369, 392.
[8] Philip et al. “Incorporation of Amino Acid-Functionalized Ionic Liquids into Highly Porous MOF-177 to Improve the Post-Combustion CO₂ Capture Capacity.” Molecules. 2023, 28, 20 (2023).
[9] Sheshkovas et al. “Thermochemical Study of CO₂ Capture by Mesoporous Silica Gel Loaded with the Amino Acid Ionic Liquid 1-Ethyl-3-Methylimidazolium Glycinate.” Microporous Mesoporous Mater. 2022, 341, 112113.
[10] Dong et al. “Post Synthesis of a Glycine-Functionalized Covalent Triazine Framework with Excellent CO₂ Capture Performance.” Microporous Mesoporous Mater. 2020, 306, 110475.

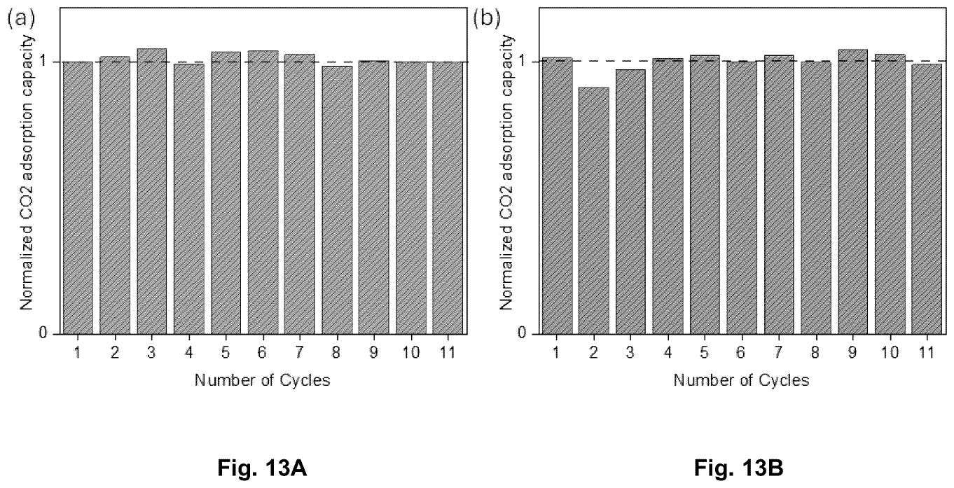

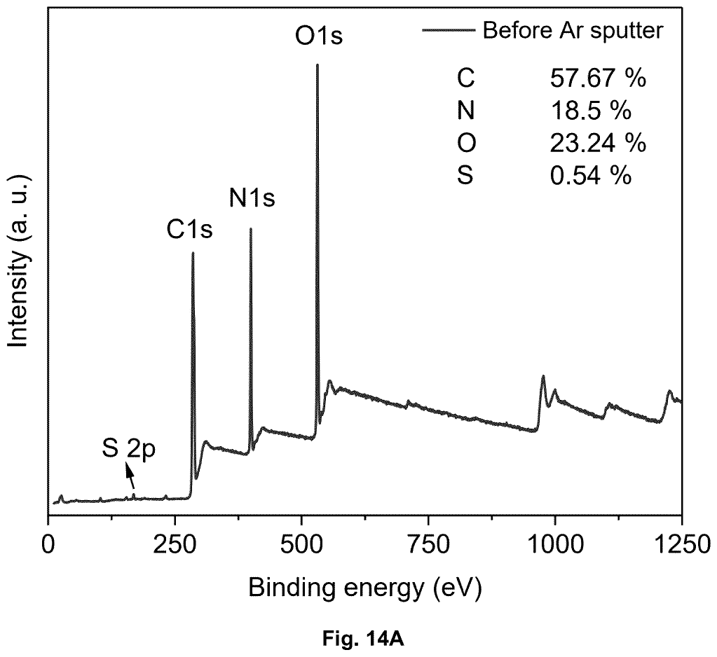

We studied the stability of the CO₂ adsorption capacity of the aerogels using 11 cycles of adsorption-desorption process and the normalized CO₂ adsorption stability is shown in FIGS. 13A-13B. The cyclic stability was checked using CO₂ gas-adsorption-desorption isotherms at 0.15 atm CO₂ at 5° C. The aerogel sol-0.06%@77K retains its adsorption capacity after 11 cycles, showing only small fluctuations, as shown in FIG. 13A. The stability of the aerogel gel-0.25%@77K was tested after exposing the samples to 90% relative humidity at 22° C. in air at atmospheric pressure overnight. The CO₂ gas adsorption-desorption isotherms were evaluated next day after degassing the aerogel using vacuum heating at 100° C. for 30 min. FIG. 13B represents the stability of the adsorption capacity at 0.15 atm CO₂ pressure obtained from the cyclic adsorption-desorption isotherms measured after humidity exposure. The retention of the adsorption capacity after multiple times of humidity exposure renders the promising stability of the sample in a humid environment. The excellent recyclability can be attributed to its efficient CO₂ desorption at low temperatures and its high thermal stability. Combined with its high sorption capacity, silk-fibroin-based sorbent shows distinct advantages over conventional amines, pure amino acids, and AAILs. In general, amines require higher desorption temperatures but have lower thermal degradation thresholds, leading to poor cycling stability in practice, a significant drawback of amine-based CO₂ adsorption technologies. In contrast, silk-fibroin-based sorbent demonstrates superior or comparable cyclic stability compared to reported amino acids and AAILs based solid sorbents (see e.g., Chatterjee et al. “Adsorption of Carbon Dioxide on Naturally Occurring Solid Amino Acids.” J. Environ. Chem. Eng. 2016, 4, 3170; Dong et al. “Post Synthesis of a Glycine-Functionalized Covalent Triazine Framework with Excellent CO₂ Capture Performance.” Microporous Mesoporous Mater. 2020, 306, 110475; Ouyang et al. “Fabrication and Adsorption Performance for CO₂ Capture of Advanced Nanoporous Microspheres Enriched with Amino Acids.” J. Colloid Interface Sci. 2018, 532, 433; Huang et al. “Study on the Efficiency of Multiple Amino Groups in Ionic Liquids on Their Sorbents Performance for Low-Temperature CO₂ Capture.” Chem. Eng. Res. Des. 2021, 167, 198; Wu et al. “Porous Polymer Supported Amino Functionalized Ionic Liquid for Effective CO₂ Capture.” Langmuir. 2023, 39, 2729; Sheshkovas et al. “Thermochemical Study of CO₂ Capture by Mesoporous Silica Gel Loaded with the Amino Acid Ionic Liquid 1-Ethyl-3-Methylimidazolium Glycinate.” Microporous Mesoporous Mater. 2022, 341, 112113; Sun et al. “Porous Amino Acid-Functionalized Poly(Ionic Liquid) Foamed with Supercritical CO₂ and Its Application in CO₂ Adsorption.” Chem. Eng. J. 2021, 412, 128764; Uehara et al. “Amino Acid Ionic Liquid-Modified Mesoporous Silica Sorbents with Remaining Surfactant for CO₂ Capture.” Adsorption. 2019, 25, 703; Uehara et al. “Effect of Water Vapor on CO₂ Sorption-Desorption Behaviors of Supported Amino Acid Ionic Liquid Sorbents on Porous Microspheres.” Ind. Eng. Chem. Res. 2017, 56, 14316; Ren et al. “Preparation and CO₂ Sorption/Desorption of N-(3-Aminopropyl)Aminoethyl Tributylphosphonium Amino Acid Salt Ionic Liquids Supported into Porous Silica Particles.” Ind. Eng. Chem. Res. 2012, 51, 7901; Erto et al. “Carbon-supported ionic liquids as innovative adsorbents for CO₂ separation from synthetic flue-gas.” J. Colloid Interface Sci. 2015, 448, 41; Wang et al. “Amino Acid-Functionalized Ionic Liquid Solid Sorbents for Post-Combustion Carbon Capture.” ACS Appl. Mater. Interfaces. 2013, 5, 8670; Hiremath et al. “Highly reversible CO₂ capture using amino acid functionalized ionic liquids immobilized on mesoporous silica.” Chem. Eng. J. 2016, 287, 602).

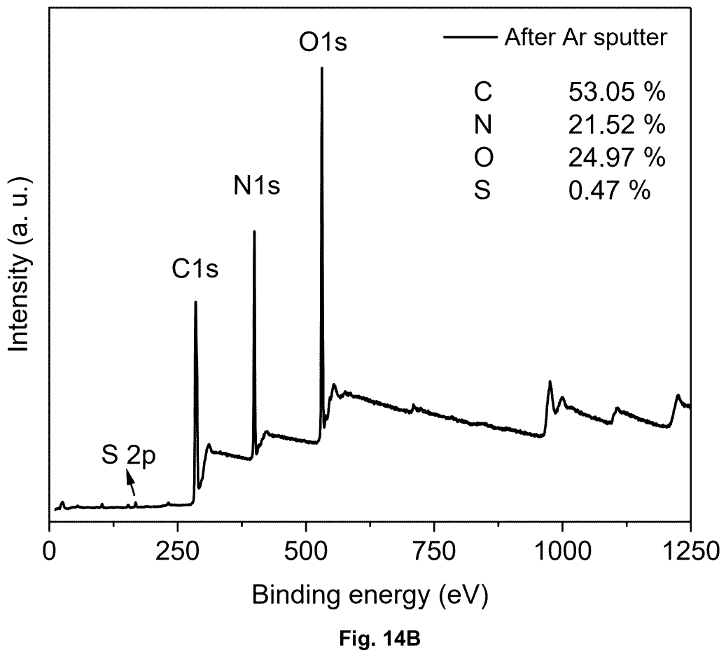

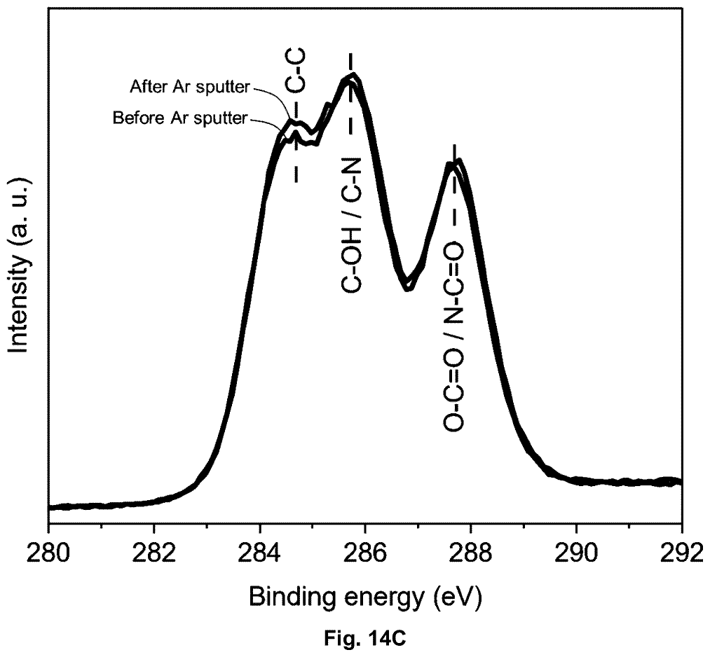

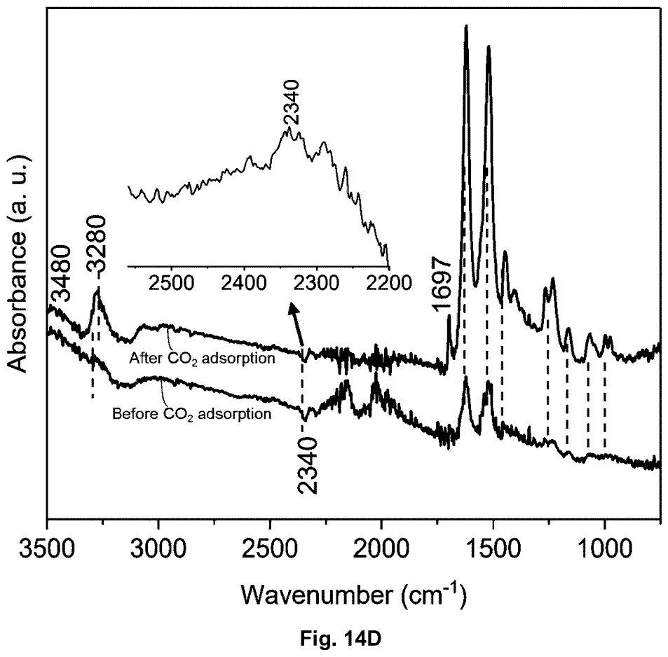

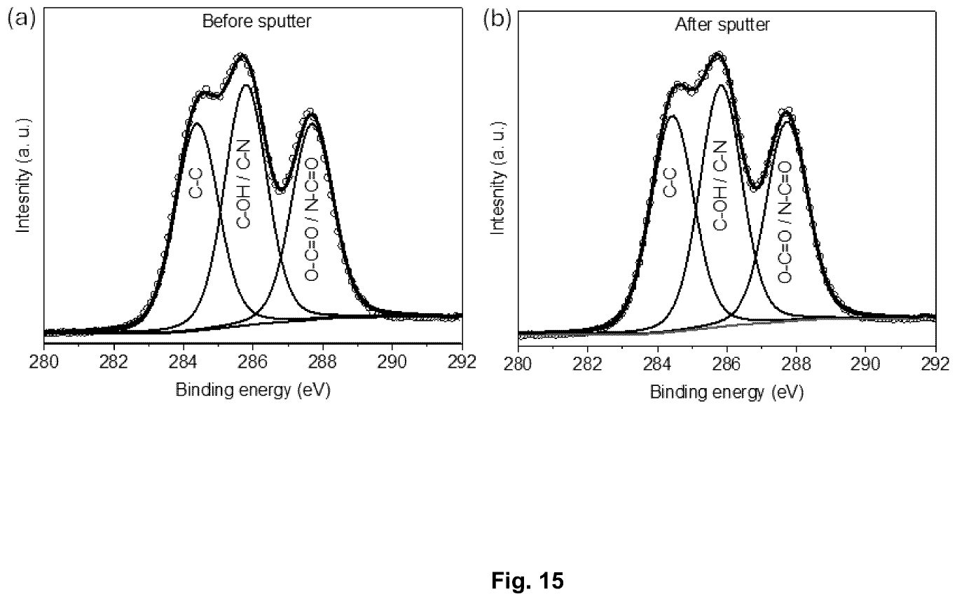

FIGS. 14A and 14B show the XPS survey scan of the SNP drop casted on a microscopic glass slide before and after Ar⁺ ion sputtering. The survey scan was fitted using Shirley type background, and the surface atomic percentages of C, N, O and S element were determined and presented in the insert of FIGS. 14A and 14B. The XPS after Ar⁺ ion sputter reveals a slight decrease in the C-content on the sample surface which may be attributed to the chemisorbed CO₂ removal from the surface upon Ar⁺ ion sputtering. The decrease in C percentage is mostly accompanied by the increase in N-percentage, i.e., the exposure of —NH₂ surface group after CO₂ removal. FIG. 14C shows the core level C1s spectra before and after Ar⁺ ion sputtering. The spectra reveal a small overall increase in the C—C peak height. The C1s spectra was fitted with Shirley type background using CasaXPS software, and the fitted plot and obtained results are shown in FIG. 15 and Table 3, respectively. The fitting of the C1s spectra agrees with the fact that the area percentage of C—C bonds slightly increases, while the area percentage of the C—OH/C—N and O—C═O/N—C═O bonds slightly decrease, suggesting the removal of CO₂ during Ar⁺ ion sputtering. Hence, the XPS analysis confirms the chemisorption of CO₂ with the —NH₂ group on the SNP surface, similar to the conventional amino acid-based systems.

TABLE 3
Fitting parameter of C1s core-level spectra of SNP before
and after Ar⁺-ion sputtering.

| | Before Ar sputter | | | After Ar sputter | | |
|---|---|---|---|---|---|---|
| | Position | | Area | Position | | Area |
| Name | (eV) | FWHM | % | (eV) | FWHM | % |
| C—C | 284.39 | 1.46 | 32.79 | 284.43 | 1.46 | 33.57 |
| C—OH/C—N | 285.79 | 1.43 | 37.42 | 285.83 | 1.43 | 36.74 |
| O—C═O/ | 287.69 | 1.40 | 29.79 | 287.72 | 1.40 | 29.69 |
| N—C═O | | | | | | |

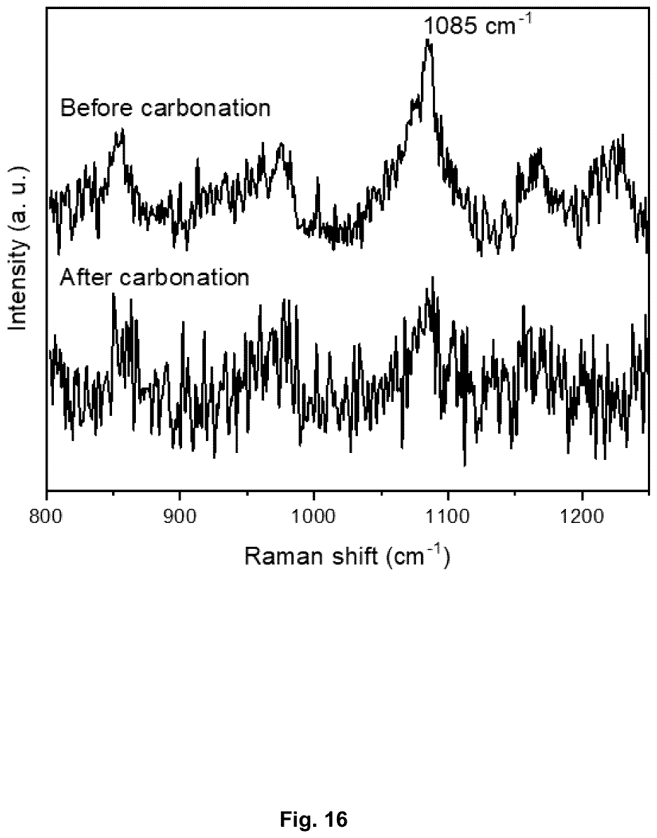

FIG. 14D represents the FTIR spectra of SNP before and after CO₂ adsorption. The FTIR spectra of CO₂ adsorbed SNP in aqueous dispersion exhibits peaks similar to the air exposed SNP as shown in FIG. 5D. However, the CO₂ desorbed SNP in aqueous dispersion shows different FTIR spectra compared to that of the CO₂ adsorbed SNP. In the CO₂ adsorbed SNP, a new shoulder peak emerges at 1697 cm⁻¹, which corresponds to the carbamate formation upon chemical absorption of CO₂. After CO₂ chemical adsorption, the primary amine (—NH₂) group transforms to the secondary amine (—NH) and forms a carbamate group as represented in equations (1) and (2). The peak at 3281 cm⁻¹ is associated with the secondary amine (—NH). However, the peak associated with the primary amine (—NH₂) group in CO₂ desorbed SNP sample is positioned at slightly higher wavenumber and overlapped with the broad hydroxyl group peak at 3480 cm⁻¹, not clearly distinguishable. Wu et al. also observed similar shift in the N—H band peaks after CO₂ chemical adsorption (Wu et al. “Porous Polymer Supported Amino Functionalized Ionic Liquid for Effective CO₂ Capture.” Langmuir. 2023, 39, 2729). The inset of FIG. 14D represents the FTIR spectra of CO₂ adsorbed SNP after subtracting the FTIR spectra of the CO₂ desorbed SNP. The enlarged peak at 2340 cm⁻¹ obtained after subtraction reveals the asymmetric stretching mode bands of the physically adsorbed CO₂ molecule. CO₂ adsorption mechanism of gel-0.25%@77K aerogel was studied using Raman spectroscopy, as represented in FIG. 16. The CO₂ adsorbed sample which was exposed to a CO₂ atmosphere prior to measurement and sealed in CO₂ environment, while the other sample was heated at 90° C. for 30 minutes to desorb any captured CO₂ and sealed in CO₂ free environment. Raman analysis revealed a significant increase in the carbonate (CO₃²⁻) peak at approximately 10⁸⁰ cm⁻¹ in the CO₂-adsorbed sample compared to the CO₂ desorbed sample, confirming the chemisorption of CO₂ molecule on the silk-fibroin sorbent surface. The FTIR and Raman spectra analysis shows that silk-fibroin-based sorbents captures CO₂ by both chemical absorption at the amine group sites and physical adsorption on the free surface area, consistent with the heterogeneity in the ΔH_{ads} measurement. The coexistence of chemical absorption and physical adsorption could be the reason for its high CO₂ adsorption capacity.

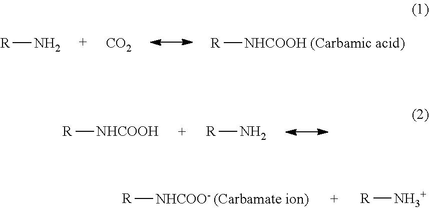

Overall, this Example found that the amino acid blend in natural silk fibroin has significant potential to adsorb CO₂. Silk fibroin mostly contains glycine (46%), alanine (30%), serine (12%) and tyrosine (5%), and all of them have one amine group in their molecular structure which could react with and chemisorb CO₂ molecule as represented in equations 1 and 2. These amino acids in pure form have already been reported to show CO₂ adsorption properties. This study reveals that silk has advantages over these pure amino acids in terms of CO₂ adsorption capacity, robust thermal stability, and cyclic adsorption-desorption stability.

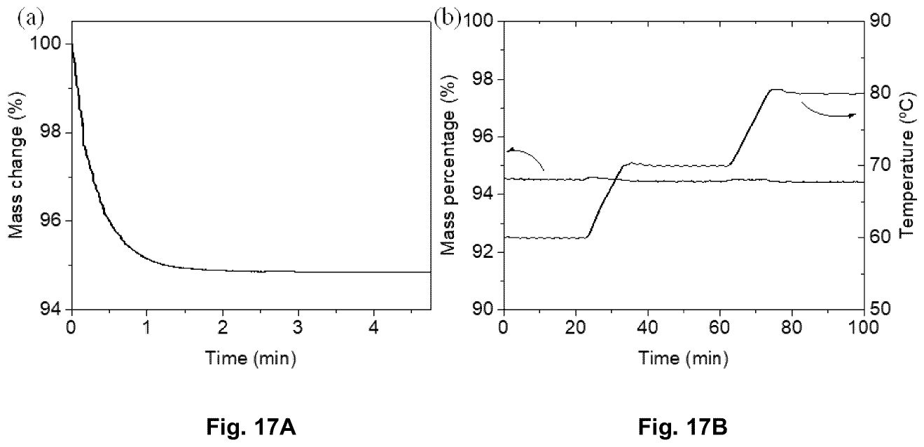

FIG. 17A presents the CO₂ desorption kinetics of gel-0.25%@77K sample at 60° C. The sample releases all the adsorbed CO₂ within 2 minutes, demonstrating the very fast sorbent regeneration that can be attributed to its low heat of adsorption. To study CO₂ desorption kinetics, the CO₂ adsorption was first performed by keeping the aerogel in 1 atm CO₂ gas environment at 23° C. for 15 minutes. Its mass change was then measured in 1 atm CO₂ environment at 60° C. using TGA. Note that increasing the sample temperature from 60 to 80° C. resulted in no noticeable mass change, as shown in FIG. 17B. This suggests that sorbent regeneration was complete at 60° C. The low-temperature sorbent regeneration reveals the promising potential of self-supported silk-fibroin aerogel for energy-efficient CO₂ capture.

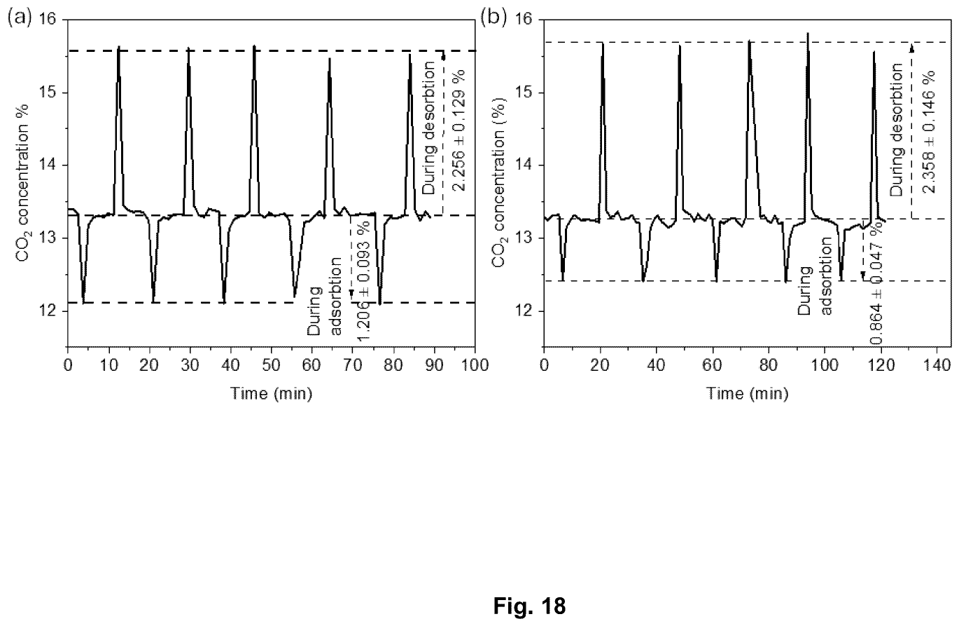

FIG. 18 show the CO₂ adsorption-desorption study in dry and humid conditions, respectively, using ~13.3% CO₂ balanced N₂ gas. The adsorption capacity in the dry and moist conditions was compared by studying their desorption at 60° C. while sending the same dry CO₂/N₂ gas mixture through the sample holder tube. As the sample holder is transferred to a water bath at 5° C., the CO₂ gas concentration in the outlet of the sample holder showed a sudden decrease, suggesting the CO₂ adsorption by the aerogel. As the CO₂ adsorbed sample is transferred to the water bath at 60° C., the CO₂ gas concentration in the sample holder outlet suddenly increased, suggesting CO₂ release from the sorbent, which is consistent with the fast CO₂ desorption rate as observed in FIG. 17A. The average of 5 desorption peak heights, when the adsorption was performed in humid conditions (83±2% relative humidity), showed around a 5% increase as compared to the condition when the adsorption was performed using dry ~13.3 CO₂ balanced N₂ gas. However, the CO₂ adsorption rate of the sorbent is slightly reduced in the presence of humidity in the gas stream, as observed in the adsorption peak height difference in FIG. 18. Overall, the promising moisture stability of the CO₂ adsorption capacity and very fast adsorption-desorption kinetics make silk-fibroin-based sorbent a suitable candidate for CO₂ capture from the flue gas stream.

Further studies may be conducted to evaluate its adsorption capacity and stability in impure gas conditions, CO₂ selectivity over other common gaseous species, adsorption-desorption mechanism, as well as the overall techno-economics for different CO₂ capture applications. Additionally, the CO₂ adsorption capacity of silk-fibroin aerogel could be further optimized via microstructure engineering.

What is claimed is:

1. A method for capturing carbon dioxide (CO₂) from a CO₂-containing gas, comprising contacting the CO₂-containing gas with a sorbent comprising silk fibroin, wherein at least a portion of CO₂ in the CO₂-containing gas is captured by the silk fibroin.

2. The method of claim 1, wherein the silk fibroin is degummed.

3. The method of claim 1, wherein the silk fibroin is in a solid form.

4. The method of claim 1, wherein the silk fibroin has a nanostructure.

5. The method of claim 4, wherein the silk fibroin is in the form of nanoparticles.

6. The method of claim 5, wherein the silk fibroin nanoparticles are prepared by subjecting degummed silk fibroin to partial acid hydrolysis with an acid solution comprising H₂SO₄ to form a first dispersion comprising silk fibroin particles, mechanically separating the particles from the acid solution, redispersing the separated particles in water to form a second dispersion, freezing the second dispersion, and lyophilizing the frozen dispersion to obtain the silk fibroin nanoparticles.

7. The method of claim 4, wherein the silk fibroin is in the form of an aerogel.

8. The method of claim 7, wherein the aerogel is prepared by dissolving degummed silk fibroin in a solution comprising LiBr, and dialyzing the solution against an aqueous medium to remove LiBr to obtain an aqueous silk fibroin solution.

9. The method of claim 8, further comprising freezing the aqueous silk fibroin solution, and lyophilizing the frozen solution to obtain the aerogel.

10. The method of claim 8, further comprising allowing the aqueous silk fibroin solution to stand for a period time to form a hydrogel.

11. The method of claim 10, further comprising freezing the hydrogel, and lyophilizing the frozen hydrogel to obtain the aerogel.

12. The method of claim 10, further comprising preparing the aerogel from the hydrogel using CO₂ or N₂ critical point drying.

13. The method of claim 1, wherein the silk fibroin has a specific surface area ranging from 50-1500 m²/g as measured by the Brunauer-Emmett-Teller (BET) method.

14. The method of claim 1, wherein the silk fibroin has an effective pore volume ranging from 0.1 to 0.8 cc/g.

15. The method of claim 1, further comprising regenerating the sorbent after the CO₂ capture at a temperature not exceeding 100° C.

16. The method of claim 1, wherein the sorbent is free of solid or porous support.

17. The method of claim 1, further comprising, prior to contacting the CO₂-containing gas, reinforcing the sorbent by incorporating into the sorbent a reinforcing material selected from a polymer, a fiber, and a nanoparticle.

18. The method of claim 17, wherein the reinforcing material comprises a graphene or carbon-based material.
